(19) United States
(12) Patent Application Publication
(10) Pub. No.: US 2026/0140700 A1
(43) Pub. Date: May 21, 2026

(54) METHODS AND APPARATUSES FOR AN ARITHMETIC LOGIC UNIT OF A COMPUTATIONAL PROCESSOR

(71) Applicant: Taiwan Semiconductor Manufacturing Company, Ltd., Hsin-Chu (TW)

(72) Inventors: Win-San KHWA, Taipei City (TW); Ashwin Sanjay LELE, San Jose, CA (US); Bo ZHANG, San Jose, CA (US); Meng-Fan CHANG, Taichung City (TW)

(21) Appl. No.: 18/951,576

(22) Filed: Nov. 18, 2024

(51) Int. Cl. G06F 7/556

(52) U.S. Cl. CPC G06F 7/556

(57) ABSTRACT

A circuit is configured for transforming input data in a neural network to output data. The circuit includes inter-connected arithmetic logic circuits and a control circuit sending a sequence of configuration settings to configure the inter-connected arithmetic logic circuits over one or more cycles. The inter-connected arithmetic logic circuits jointly perform at least one of a softmax or a sigmoidal linear unit (SiLU) operation on the input data. The inter-connected arithmetic logic circuits include an exponential circuit generating a first exponential of a fractional part of an input and a second exponential of an integer part of the input, a multiplier circuit multiplying the first exponential and the second exponential into a first intermediate variable, an accumulator circuit summing multiple intermediate variables relating to exponentials of multiple inputs, and a reciprocal circuit generating a reciprocal of a second intermediate variable that is input to the reciprocal circuit.

### BACKGROUND

An artificial intelligence (AI) system may be built on a software-based neural network model implemented on one or more AI accelerators, such as a graphics processing unit (GPU), tensor processing units (TPUs), and/or the like. The AI accelerator may comprise a specialized component and/or device to accelerate the execution of AI and machine learning workloads. Existing AI accelerators and/or processors largely rely on software frameworks and libraries to perform complex computational tasks. The power consumption of such AI accelerators and/or processors can be significant due to the intense computational demands of AI systems.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an example of neural network model involving computational operations to perform a classification task, according to one or more embodiments described herein.

FIG. 2 is a simplified diagram illustrating an example structure of a hardware-based computation arithmetic logic unit (ALU) for performing a Softmax or a sigmoidal linear unit (SiLU) operation in a neural network, according to one or more embodiments described herein.

FIG. 3 is a simplified diagram illustrating a circuit structure of a register for input register or output register shown in FIG. 2, according to one or more embodiments described herein.

FIG. 4 is a simplified diagram illustrating a circuit structure of the multiplexer-demultiplexer shown in FIG. 2, according to one or more embodiments described herein.

FIG. 5 is a simplified diagram illustrating a circuit structure of transmission gate arrays shown in FIG. 2, according to one or more embodiments described herein.

FIG. 6A is a simplified diagram illustrating a circuit structure of exponential circuit (ES) shown in FIG. 2, according to one or more embodiments described herein.

FIG. 6B is a simplified diagram illustrating a circuit structure of ES shown in FIG. 6A, according to one or more embodiments described herein.

FIG. 7A is a simplified diagram illustrating an operation of the splitter circuit described in FIG. 6C under a dequantization mode, according to one or more embodiments described herein.

FIG. 7B is a simplified diagram illustrating an operation of the ES described in FIG. 6B under a dequantization mode, corresponding to the splitter operation described in FIG. 7A, according to one or more embodiments described herein.

FIG. 8A is a simplified diagram illustrating an operation of the splitter circuit described in FIG. 6C under a quantization mode, according to one or more embodiments described herein.

FIG. 8B is a simplified diagram illustrating an operation of the ES described in FIG. 6B under a quantization mode, corresponding to the splitter operation described in FIG. 8A, according to one or more embodiments described herein.

FIG. 9A is a simplified diagram illustrating a circuit structure of the multiplier circuit shown in FIG. 2, according to one or more embodiments described herein.

FIG. 9B is a simplified diagram illustrating an operation of computing elements for a Softmax function using the MP circuit described in FIG. 9A, according to one or more embodiments described herein.

FIG. 10A is a simplified diagram illustrating a circuit structure of the AC circuit shown in FIG. 2, according to one or more embodiments described herein.

FIG. 10B is a simplified diagram illustrating a circuit structure of the AC circuit shown in FIG. 10A, according to one or more embodiments described herein.

FIGS. 11A-11D are simplified diagrams illustrating multiple cycles of operating the AC circuit shown in FIGS. 10A-10B, according to one or more embodiments described herein.

FIG. 12 is a simplified diagram illustrating a circuit structure of the RC circuit shown in FIG. 2, according to one or more embodiments described herein.

FIG. 13 is a simplified diagram illustrating a circuit structure of the control circuit shown in FIG. 2, according to one or more embodiments described herein.

FIG. 14 shows example control signal configuration for different operations.

FIG. 15 is a simplified diagram illustrating an exponential computation operation by ALU shown in FIG. 2, according to one or more embodiments described herein.

FIG. 16 is a simplified diagram illustrating a single accumulation operation by ALU shown in FIG. 2, according to one or more embodiments described herein.

FIG. 17 is a simplified diagram illustrating a single reciprocal operation by ALU shown in FIG. 2, according to one or more embodiments described herein.

FIG. 18 is a simplified diagram illustrating a single multiplication operation by ALU shown in FIG. 2, according to one or more embodiments described herein.

FIG. 19 is a simplified diagram illustrating a combined operation combining multiple single operations described in FIGS. 15-18 to perform a Softmax operation by ALU shown in FIG. 2, according to one or more embodiments described herein.

FIG. 20 is a simplified diagram illustrating a combined operation combining multiple single operations described in FIGS. 15-18 to perform a SiLU operation by ALU shown in FIG. 2, according to one or more embodiments described herein.

FIG. 21 is a simplified diagram illustrating a combined operation combining multiple single operations described in FIGS. 15-18 to perform an INT8 Softmax operation (dequantization of input and then quantization of the output) by ALU shown in FIG. 2, according to one or more embodiments described herein.

FIG. 22 is an example logic flow chart illustrating a process for transforming input data in a neural network to output data using a plurality of inter-connected arithmetic logic circuits described in FIGS. 2-21, according to embodiments described herein.

FIG. 23 is a simplified diagram illustrating a computing device implementing a neural network on an AI accelerator comprising the circuit structures described in FIGS. 1-22, according to one embodiment described herein.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

In recent years, the rapid advancements in artificial intelligence (AI) and machine learning have significantly impacted various industries, from healthcare and finance to automotive and consumer electronics. As AI systems become increasingly sophisticated, their computational demands have escalated, driving the need for more efficient and powerful processing solutions. Traditional central processing units (CPUs) often struggle to keep pace with these demands, leading to the widespread adoption of AI accelerators such as graphics processing units (GPUs) and tensor processing units (TPUs). GPUs and TPUs are better suited for AI applications than CPUs due to their ability to handle the massive parallel processing required by AI and machine learning tasks. Unlike CPUs, which are optimized for general-purpose computing, GPUs and TPUs are designed to execute thousands of operations simultaneously, making them good candidates for processing large datasets and complex algorithms. This parallelism significantly accelerates the training and inference processes in AI models, resulting in faster and more efficient computation. Additionally, GPUs and TPUs are optimized for the specific mathematical operations that underpin AI workloads, further enhancing their performance in these applications.

AI accelerators have emerged as critical components in the deployment of AI models, particularly in tasks that require massive parallel processing capabilities, such as deep learning. These specialized hardware components are designed to optimize the performance of AI workloads, enabling faster processing times and more efficient utilization of resources. However, this increased performance often comes at the cost of higher power consumption, posing significant challenges in terms of energy efficiency and thermal management.

The instant application relates to computational circuits, and more specifically to methods and apparatuses for a hardware-based application-specific circuit (ASIC) for performing neural network operations such as a softmax operation, a sigmoidal linear unit (SiLU) operation, and/or the like across different input data formats. Embodiment described herein provide an arithmetic logic unit (ALU) circuit for computing a complex neural network operation such as Softmax, or sigmoidal linear unit (SiLU) on an input data value, such as a Brain Floating Point 16-bit (BF16), half-point floating point 16-bit (FP16), 16-bit floating-point data types used primarily in machine learning and AI computations, or an 8-bit integer (INT8).

In one embodiment, the ALU circuit supports both Softmax and SiLU operations with data and hardware reuses across different number formats. The ALU hardware comprise arithmetic units (e.g., addition, multiplication, reciprocal, and exponential) interleaved with Mux-Demux (MD) units to form different data paths among the arithmetic units. Hardware reuse between complex functions and basic arithmetic operations is achieved by decomposing complex functions (such as Softmax, SiLU) into basic arithmetic operations (e.g., addition, multiplication, reciprocal, and exponential) and controlling the MD units to control the input and output data paths corresponding to different arithmetic operations.

In one embodiment, hardware reuse between number formats is achieved by splitting the operand bits into {sign, exponent, and mantissa} fields according to the definition of FP16, BF16, and INT8.

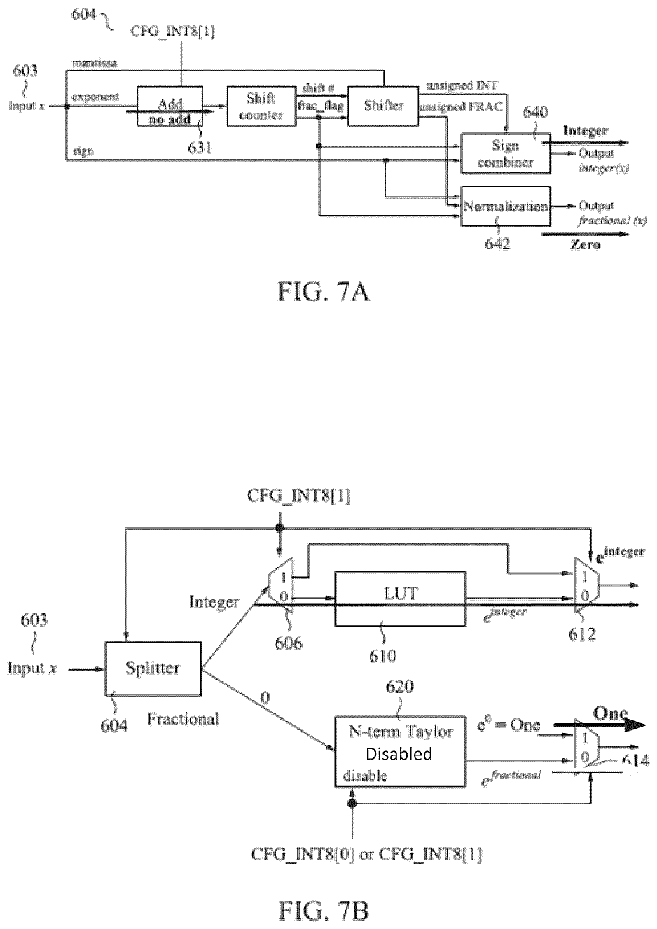

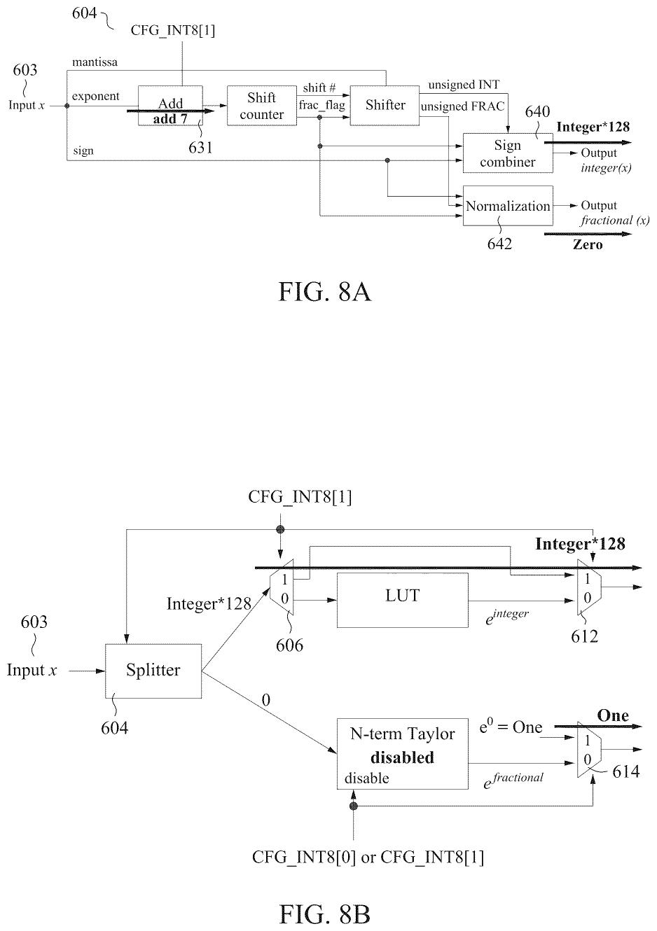

In one embodiment, the ALU circuit further supports integer-mode softmax with hardware reuse from sharing integer dequantization and quantization units in float-point lookup table (LUT)-Taylor based exponential units. The dequantization step is replaced with the LUT that already exists in the ALU. The integer input is converted to LUT address and the LUT provides exponential output in floating point, as further described in FIGS. 7A-7B. The quantization step is replaced with the exponent splitter and a 128× rescale. The 128× rescale is implemented by adding seven to the exponent bits (or minus seven from the exponent bias), as further described in FIGS. 8A-8B.

In this way, the computation ALU may be applicable in AI accelerators as an on-chip ALU for complex operations, e.g., softmax and SiLU, and/or the like. Such hardware-based computation allows fast convergence and high accuracy for computations, as well as efficient circuit area usage and low energy consumption. Also, the hardware-based computation ALU unit requires fewer GPU memory accesses, compared to software-based computation on GPUs. Hardware efficiency of neural network deployment is thus improved.

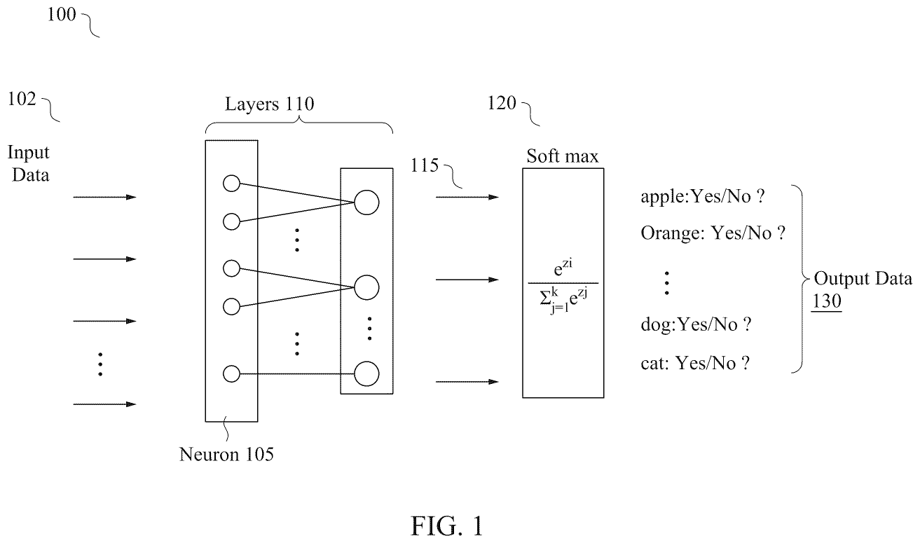

FIG. 1 illustrates an example of neural network model 100 involving computational operations to perform a classification task, according to one or more embodiments described herein. In one embodiment, a neural network 100 comprises a computing system that is built on a collection of connected units or nodes, referred to as neurons 105. Neurons are often connected by edges, and an adjustable weight is often associated with the edge. The neurons are often aggregated into layers 110 such that different layers may perform different transformations on the respective input and output transformed input data onto the next layer.

For example, an input layer receives the input data 102 as each neuron receives input signals, performs a weighted sum of the inputs according to weights assigned to each connection, and then applies an activation function associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, SiLU, and/or the like. In this way, after a number of layers, input data 102 received at the input layer is transformed into rather different values indicative data characteristics corresponding to a task that the neural network structure has been designed to perform.

For example, the input data 102 may comprise an image, and the neural network 100 may be a classification model trained to classify an object in the input image. The input image may be processed by layers 100 of transformation including activation functions such as SiLU. For example, the activation of the SiLU is computed by the sigmoid function multiplied by its input:

$${SiLU ( x )}_{i} = \frac{{x}_{i}}{1 + {e}^{- {x}_{i}}}$$

where x_i represents the input data value to the SiLU.

The output layer may output logits 115 indicating a likelihood that the input image may contain one of pre-defined object classes, e.g., apple, orange, . . . , dog, cat. A softmax operation 120 may be performed to generate output probabilities over the classes based on output logits at the output layer. For example, the Softmax operation is a normalized exponential function:

$${softmax ( x )}_{i} = \frac{{e}^{{x}_{i} - max ( x )}}{{\sum }_{j = 1}^{n} {e}^{{x}_{i} - max ( x )}}$$

where x represents a vector of output probabilities over n classes. In this process, the operation of the neural network 100 involves a significant number of exponential computations, e.g., in the softmax operation, in a SiLU operation, and/or the like.

Traditionally, these complex operations such as softmax or SiLU are mostly performed via software implemented on GPU, TPUs or other AI accelerators. Conventional AI accelerators typically have dedicated hardware for different number formats that leads to higher circuit area overhead. Furthermore, performing complex activation functions in neural networks, such as Softmax, in integer-mode typically involves (1) dequantization of integer inputs to floating point, (2) arithmetic operation in floating point, and (3) quantization of the floating point outputs back to integer. The dequantization and quantization operations are again typically handled by additional dedicated hardware that are hard-wired in silicon, further increasing the circuit area overhead.

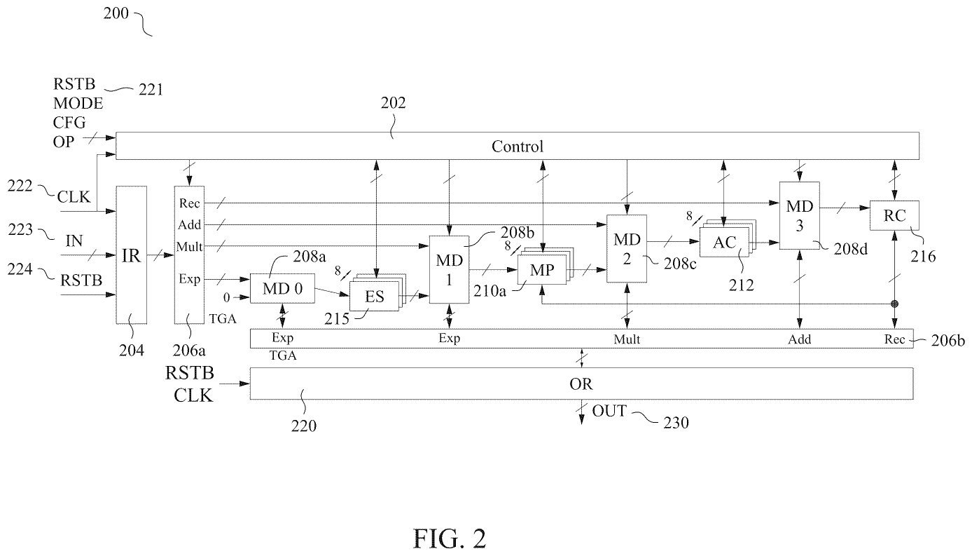

FIG. 2 is a simplified diagram illustrating an example structure of a hardware-based computation ALU 200 for performing a Softmax or a SiLU operation in a neural network, according to one or more embodiments described herein. ALU 200 may comprise multiple logic circuits such as input register (IR) 204, transmission gates arrays (TGAs) 206a-b, multiple multiplexer-demultiplexer (MD) 208a-d, accumulator circuit (AC) 212, multiplier circuits (MP) 210, exponential computation circuit (ES) 215, reciprocal circuit (RC) 216, output register (OR) 220, and/or the like. These arithmetic logic circuits may be inter-connected to jointly perform a computation on an input data value 223 according to different control configuration settings, and output an output value 230.

In one embodiment, ALU 200 may further comprise a control circuit 202 that receive a control signal 221 and in turn configure various circuit modules within ALU 200. For example, the control signal 221 may comprise a reset (RST) bit, bits representing the mode of the input data value (MODE=number format, FP8 or BF16), bits representing configurations for one of ES, AC, RC or MP (CFG), bits representing an operation for one of ES, AC, RC or MP (OP), and/or the like. Control circuit 202 may receive the control signal 221 and in turn configure the circuits ES, MDs, MP, AC, RC based on the control signal 221.

In one embodiment, control circuit 202 and IR 204 may be synchronized by the clock signal 222 and/or reset by the RSTB 224. In this way, an input data value 223 of format FP8, BF16, FP16, and/or the like, e.g., representing an intermediate variable in one of the layer 110 of neural network 100 shown in FIG. 1, is input to ALU 200 to compute an output value 230 of format FP8, BF16, FP16, and/or the like, accordingly. Depending on the computation type configured by various control settings according to the control signal 221, the output value 230 may represent a Softmax operation result, a SiLU operation result, and/or the like of the input value 223.

In one embodiment, ALU 200 may support both FP16 and BF16 data format for the input data value 223. For example, data types FP16 and BF16 have different number of bits for exponent and mantissa: FP16={1b sign, 5b exponent, 10b mantissa}, BF16={1b sign, 8b exponent, 7b mantissa}. Each arithmetic unit such as ES, MD, MP, AC or RC may accommodate the largest bit-width of each component among FP16 and BF16, while the data propagation between units are kept at either FP16 or BF16.

Specifically, inside each arithmetic unit ES, MD, MP, AC or RC, each data variable in the format of FP16 or BF16 may be padded with leading or trailing zeros to take the form of {1b sign, 8b exponent, 10b mantissa}. For example, for both FP16 and BF16 data types, the original 1 bit of sign remain unchanged. For FP16 data type, the 8-bit exponent may be padded with zeros as {3′b0, 5b exponent} or {5b exponent, 3′b0}, and the 10-bit mantissa remain unchanged. For BF16 data type, the original 8-bit exponent remain unchanged, and the 10-0bit mantissa is padded with zeros as {3′b0, 7b mantissa} or {7b mantissa, 3′b0}. Across arithmetic units ES, MD, MP, AC or RC, the data types FP16 or BF16 remain unchanged.

In one embodiment, one or more multiplexer-demultiplexer (mux-demux) units MD 208a-208d may be interleaved with the plurality of inter-connected arithmetic logic circuits. These MD 208a-208d are controlled by one or more selection signals to form one or more data paths among the inter-connected arithmetic logic circuits. The one or more data paths correspond to a sequence of arithmetic operations performed by one or more of the inter-connected arithmetic logic circuits. The sequence of arithmetic operations such as exponential, accumulation, multiplication, reciprocal, when combined in a specific order, may jointly form a complex operation such as softmax or SiLU operation.

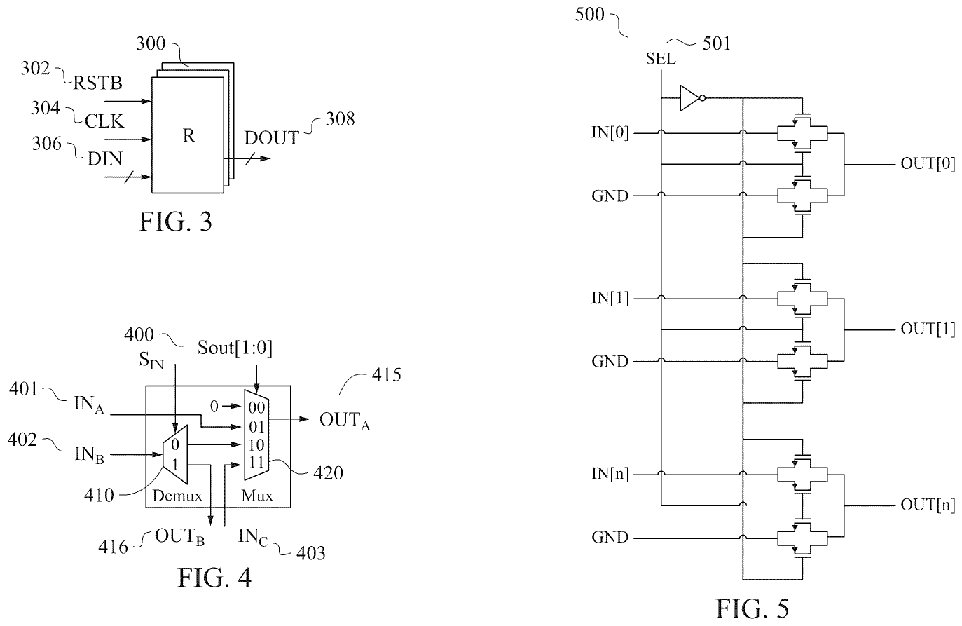

FIG. 3 is a simplified diagram illustrating a circuit structure of a register for IR 204 or OR 220 shown in FIG. 2, according to one or more embodiments described herein. In one embodiment, the register circuit 300 may have synchronous input and output. The input side of the register circuit 300 may comprise multiple input pins for one-bit reset signal (RSTB) 302 used to reset the register, a one-bit clock signal 304 to synchronize and multiple bits for an input value 306. Input value 306 may be captured by the register circuit 300 at the rising edge of the clock signal 304, and then output from the register circuit 300 as DOUT 308 at the rising edge of the clock signal 304.

FIG. 4 is a simplified diagram illustrating a circuit structure of the MD 208a-208d shown in FIG. 2, according to one or more embodiments described herein. As shown in FIG. 4, MD 208a-208d may take a circuit structure 400 comprising a demultiplexer 410 connected to a multiplexer 420 which jointly controls a data path between input IN_{A} 401 and IN_{B} 402 to output OUT_{A} 415 and OUT_{B} 416. For example, t eh demultiplexer 410 may receive a one-bit IN_{B} 402 and output IN_{B} 402 to OUT_{B} 416 when Sn is 1. Otherwise, when Su is 0, IN_{B} 402 is passed to the input of multiplexer 420.

In one embodiment, IN_{A} 401 is passed to multiplexer 420. In this way, when the selection signal S_{OUT} is 00, OUT_{A} 415 is 0; when the selection signal S_{OUT} is 01, IN_{A} 401 is passed to OUT_{A} 415; when the selection signal S_{OUT} is 10, IN_{B} 402 is passed to OUT_{A} 415; when the selection signal S_{OUT} is 11, IN_{C} 403 is passed to OUT_{A} 415.

FIG. 5 is a simplified diagram illustrating a circuit structure of TGA 206a-206b shown in FIG. 2, according to one or more embodiments described herein. In one embodiment, the TGA circuit 500 may comprise n pairs of transmission gates, each connected to an input bit IN and a ground signal. The input data IN[0:n] is then selectively passed to output end OUT[0:n]. When the selection signal 501 is 1′b1 (e.g., 1-bit wide unsigned integral value=1), the input is passed to the output OUT, e.g., IN[i]=OUT[i], i=0, 1, . . . , n. Otherwise, when the selection signal 501 is 1′b0 (1-bit wide unsigned integral value=0), the output end OUT[i]=GND.

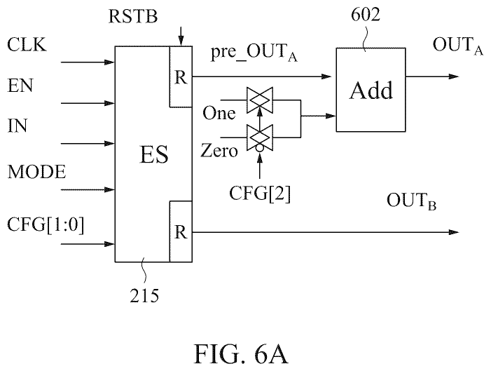

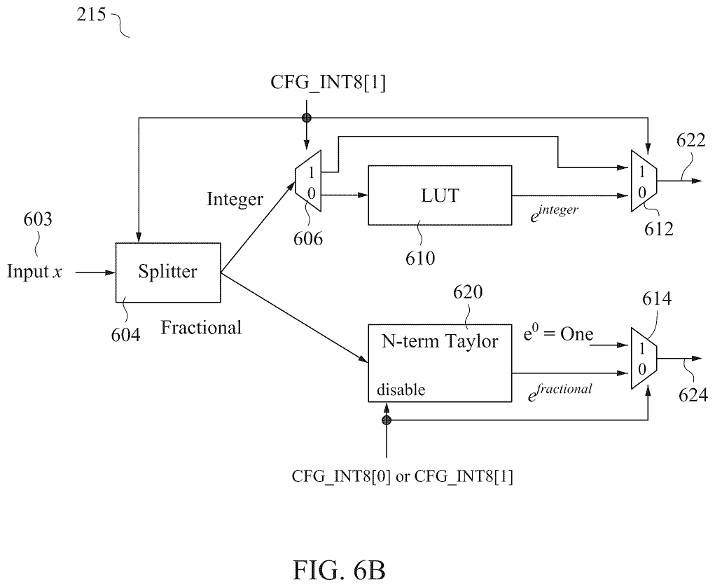

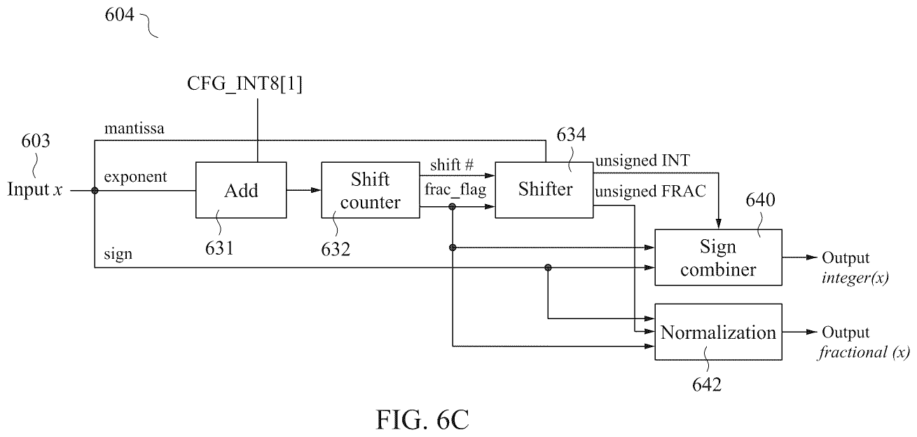

FIG. 6A is a simplified diagram illustrating a circuit structure of ES 215 shown in FIG. 2, according to one or more embodiments described herein. In one embodiment, ES circuit 215 may receive a clock signal CLK, an enabling signal EN, input data value IN (e.g., in FP16 or BF16 data format), a mode signal MODE indicating the input data format, and control setting CFG. Specifically, CFG[1:0] indicates the number of cycle the exponential computation takes, and CFG[2] indicates whether the negative exponential plus one mode is enabled to compute 1+e^{-x} given the input value x.

Operation of ES 215 may be synchronized by the clock signal CLK. For example, when EN=1, and CLK is at the rising edge, ES 215 may compute the exponential of IN by splitting IN into to operands IN_{A} (integer part) and IN_{B} (fractional part) and computes their exponential separately. Additional circuit details of computing the exponentials of operands IN_{A} (integer part) and IN_{B} (fractional part) are further provided in FIG. 6B.

In one embodiment, the computed exponential results of operands IN_{A} (integer part) and IN_{B} (fractional part) are driven to OUT_{A} and OUT_{B} after N cycles, as defined by CFG[1:0]. The ES sat may comprise registers such that both OUT_{A} and OUT_{B} are registered

Specifically, if CFG[2]=1′b1, meaning the negative exponential plus one mode is enabled, then the sign bit of the input IN is inverted and an one is added to one of the output (i.e. pre_OUT_{A}) at adder 602 to generate the final OUT_{A}.

FIG. 6B is a simplified diagram illustrating a circuit structure of ES 215 shown in FIG. 6A, according to one or more embodiments described herein. As shown in FIG. 6B, ES 215 comprises a splitter circuit 604, a demultiplexer 606, a lookup (LUT) table circuit 610, a Taylor term computation circuit 620, and multiple multiplexers 612, 614.

In one embodiment, neural network weights, such as taking a data format of FP16 or BF16, may be quantized to reduce the precision of the weights from a higher bit-width (e.g., 16-bit floating point) to a lower bit-width (e.g., 8-bit integers). Quantization of weights helps reduce the memory footprint and computational requirements of the neural network, making it more efficient for deployment, especially in resource-constrained environments like mobile devices and edge computing. For example, for an 8-bit quantization, the continuous range of weights might be mapped to the integer range [−128, 127]. During inference, the quantized weights are dequantized back to floating-point for computation, but they retain their reduced precision. For example, for Softmax operation which entails an exponential normalization function that produces fractional outputs, under integer mode, an integer input is first converted to floating point first (e.g., dequantize), the arithmetic operations are conducted in floating point, and then the floating output back to integer mode (e.g., quantization). Traditionally, both dequantization and quantization require separate and dedicated hardware. Here, as shown in FIGS. 6B-6C, ES 215 operates under quantization or dequantization mode using same hardware circuits using control signals CFG_INT8[1] and CFG_INT8[0].

In one embodiment, given an input data value 603 (e.g., similar to IN in FIG. 6A, which may be of FP16 or BF16 format), the splitter circuit 604 is configured to split the input data 603 into an integer part and a fractional part. An example circuit structure of the splitter circuit 604 is further described below in FIG. 6C.

The integer part may be passed to demultiplexer 606 controlled by control signal CFG_INT8 indicating whether dequantization or quantization of the integer part is taking place. For example, the ES circuit 215 supports integer-mode computation (e.g., input data 604 has an INT8 format) with hardware reuse from sharing integer dequantization and quantization units in float-point LUT-Taylor based units 610 and 620.

Specifically, when CFG_INT8[1] is 0, meaning dequantization mode is chosen for INT8 input data 603, the integer part is passed to the LUT circuit 610. The integer part is converted to LUT address to the LUT 610 which may retrieve a pre-stored exponential value e^{integer} in floating point. Here when input data 603 is an integer, the fractional part of input data 603 is 0, and therefore the exponential of the fractional part outputs 1. When CFG_INT8[1] is 1, meaning quantization mode is chosen, a 128× rescaling is implemented by adding 7 to the exponent bits (or minus seven from the exponent bias).

In one embodiment, the fractional part from the splitter circuit 604 may be sent to the Taylor term computation circuit 620, which may in turn compute a sum of a finite number of Taylor expansion terms of the fractional part as an approximation of e^{fractional}. Similar to the integer part, control signal CFG_INT8[1] or CFG_INT8[0] indicating whether a dequantization mode or quantization mode is taking place is used to enable or disable the Taylor term computation circuit 620. For example, when CFG_INT8[1] indicates dequantization mode is chosen, the Taylor term computation circuit 620 is not disabled (thus enabled) because the fractional part is 0, and thus e^{fractional}=1. Or when CFG_INT8 indicates quantization mode is chosen, the fractional part is zero after rescaling with 128, and therefore e^{fractional}=1. The multiplexer 614 may further select to pass on an output 624 as the exponential of the fractional part, e.g., 1 or e^{factional} according to the control signal CFG_INT8[1] indicating whether the circuit is operating under quantization/dequantization mode, or FP mode.

In this exponential computation circuit shown in FIG. 6B, the Taylor term computation circuit 620 adopts a pre-defined fixed number of terms for Taylor expansion e.g., N=3, 4, 5, etc.

Traditionally, after computing the exponential of the integer part 622 and the exponential of the fractional part 624, a multiplier is used to multiple the two parts to generate the final exponential value of the input value 603. In FIGS. 6A-6B, ES 215 may output the exponential of the integer part 622 and the exponential of the fractional part 624, separately, and reuse MP 210a in ALU 200 in FIG. 2 for the multiplication.

FIG. 6C is a simplified diagram illustrating an example structure of a splitter circuit 604 described in FIG. 6B, according to one or more embodiments described herein. The splitter circuit 604 may comprise an adder 631, a shift counter 632, a shifter 634, a sign combiner 640 and a normalization circuit 642.

In one embodiment, the input data value 603, e.g., in BF16 or FP16 data format, may be decomposed into its sign, mantissa, and exponent, as described in relation to FIG. 2. Specifically, the adder circuit 631 may add 7 to the exponent depending on the control signal CFG_INT8[1] indicating whether a dequantization or quantization mode is taking place. For example, when CFG_INT8[1]=1′b1, indicating a quantization mode, the adder circuit 631 adds 7 to the exponent bits or subtract 7 from exponent bits.

The adder result is passed to the shifter counter 532, which may then shift a number of bits for the exponent bits, resulting in the number of shifted bits and a fractional flag part (indicating whether a fractional part exists). Both of these outputs from the shift counter 632 are then passed to the shifter circuit 634, together with the mantissa bits. The shifter circuit 634 may then shift bits to generate an unsigned integer part INT, and an unsigned fractional part FRAC.

The sign combiner circuit 640 may combine the sign bit from input value 603, the fractional flag and the unsigned integer INT to output the integer part integer(x). The normalization circuit 642 may in turn combine the sign bit, the fractional flag and the unsigned fractional part FRAC, and in turn normalizes the unsigned fractional part FRAC to output the fractional part fractional(x).

FIG. 7A is a simplified diagram illustrating an operation of the splitter circuit 604 described in FIG. 6C under a dequantization mode, according to one or more embodiments described herein. When control signal CFG_INT8[0]=1 and CFG_INT8[1]=0, splitter circuit 604 is operated under a dequantization mode. Input value x 603 may represent a neural network weight that has been mapped to 8-bit integers (INT8) in the range of [−128, 127].

In this case, the adder circuit 631, as controlled by control signal CFG_INT8[1]=0, does not add any value to the exponent of input value 603, when control signal CFG_INT8[1]=0. In other words, the original exponent bits are passed to shift counter as described in relation to FIG. 6C. In this way, the sign combiner circuit 640 outputs the original integer part of the input value 603. For input value 603 in the form of INT8, the fractional part is zero, and thus the normalization circuit 642 outputs the fractional(x) as zero.

FIG. 7B is a simplified diagram illustrating an operation of the ES 215 described in FIG. 6B under a dequantization mode, corresponding to the splitter operation described in FIG. 7A, according to one or more embodiments described herein. When CFG_INT8[0]=1 and CFG_INT8[1]=0 indicating a dequantization mode, splitter circuit 604 outputs the original integer part integer of input value 603, and a fractional part of 0. The demultiplexer 606 may, as controlled by control signal CFG_INT8[1]=1, pass the integer part integer to LUT circuit 610, which may retrieve a pre-stored exponential value i^{nteger} in floating point. The multiplexer 612 may then select, as controlled by control signal CFG_INT8[1]=0, the FP e^{integer} value from LUT circuit 610 as the exponential of integer part.

In one embodiment, for the fractional part=0, the multiplexer 614 may further select, as controlled by control signal CFG_INT8[0]=1, to pass on e⁰=1 as the exponential of the fractional part.

FIG. 8A is a simplified diagram illustrating an operation of the splitter circuit 604 described in FIG. 6C under a quantization mode, according to one or more embodiments described herein. When control signal CFG_INT8[0]=0 and CFG_INT8[1]=1, splitter circuit 604 is operated under a quantization mode. Input value x 603 may represent a floating point value, which may be a result of an operation such as Softmax, 0.045, −0.132, 0.913 of 16-bit precision.

Specifically, to map the FP input value x 602 to INT8 (quantize), the adder circuit 631, as controlled by control signal CFG_INT8[1]=1, may add 7 to the exponent of input value 603 (equivalent to multiplying the input value 603 by 27=128). In other words, the original exponent bits plus 7 are passed to shift counter as described in relation to FIG. 6C. In this way, the sign combiner circuit 640 outputs the integer part, which is the original integer part of the input value 603 scaled by 27=128, e.g., integer×128.

For the fractional part, after the input value x being mapped to 8-bit integers (INT8) in the range of [−128, 127], the fractional part is zero from splitter circuit 604.

FIG. 8B is a simplified diagram illustrating an operation of the ES 215 described in FIG. 6B under a quantization mode, corresponding to the splitter operation described in FIG. 8A, according to one or more embodiments described herein. In one embodiment, when CFG_INT8[0]=0 and CFG_INT8[1]=1 indicating a quantization mode, splitter circuit 604 outputs an integer part as integer×128, and a fractional part of 0. The demultiplexer 606 may, as controlled by control signal CFG_INT8[1]=1, pass the integer part integer×128 directly from splitter circuit 604 to the multiplexer 612. Here, LUT 610 is no longer needed because the ES 215 is configured to quantize an output (exponential has already been computed). The multiplexer 612 may then select, as controlled by control signal CFG_INT8[1]=1, the integer×128 value as the output of the integer part.

In one embodiment, for the fractional part=0, the multiplexer 614 may further select, as controlled by control signal CFG_INT8[1]=1, to pass on e⁰=1 as the output of the fractional part.

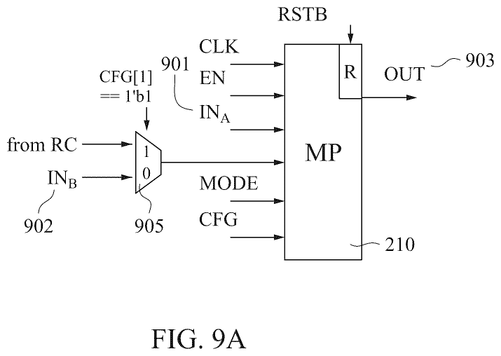

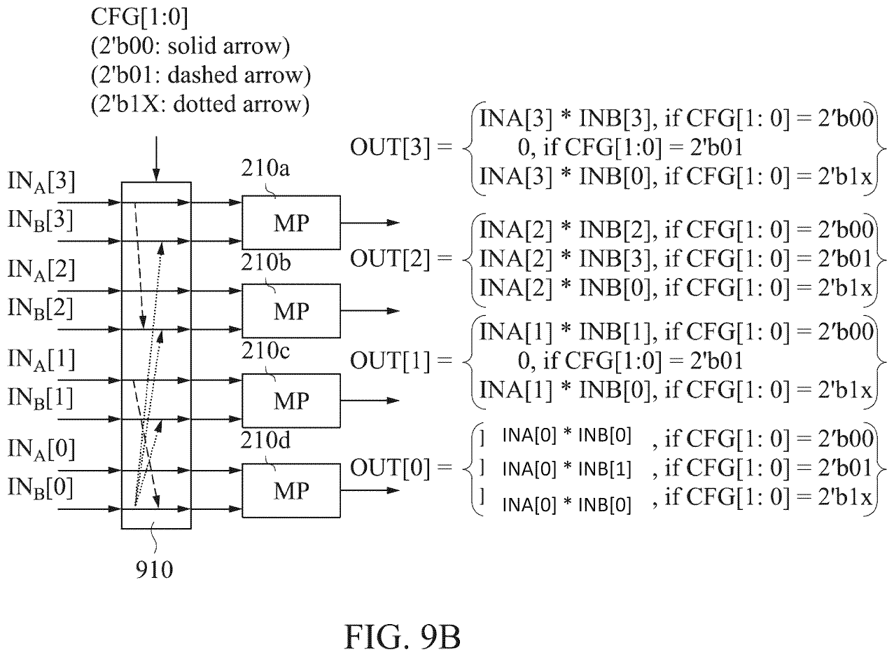

FIG. 9A is a simplified diagram illustrating a circuit structure of the MP 210 shown in FIG. 2, according to one or more embodiments described herein. In one embodiment, MP 210 may generate a multiplication output 903 of input IN_{A} 901 and input IN_{B} 902 subject to various control signals. MP 210 is synchronized with other circuits in ALU 200 shown in FIG. 2 with the clock signal CLK, and may be reset by the RST signal. The EN signal enables the MP circuit 210; the MODE signal indicates the number format for the MP circuit 210; the CFG control signal contains two bits to indicate three configurations, e.g., CFG[1:0]=2′b00, multiplication is made between each MP element's IN_{A} and IN_{B}; CFG[1:0]=2′b01, multiplication is made between IN_{A} of different MP elements; and CFG[1:0]=2′b1X, multiplication is made between IN_{A} of each MP elements with IN_{B}[0] multi-casted.

In one embodiment, the CFG[1] control signal may select, by the multiplexer 905, whether input IN_{B} 902 or the output from RC circuit 216 is to be multiplied with input IN_{A} 901. Additional details of operating the MP circuit 210 in conjunction with other circuit modules in ALU 200 may be described in relation to FIGS. 9A-9B.

FIG. 9B is a simplified diagram illustrating an operation of computing elements for a Softmax function using the MP circuit 210 described in FIG. 9A, according to one or more embodiments described herein. In one embodiment, it is to be noted that in the example shown in FIG. 9B, 4 MP circuits 210a-210d are placed in parallel in one implementation. In another implementation, only one MP circuit 210 may be used to perform the multiplication operations in sequence.

In one embodiment, a connection array 910 may connect bits of input values IN_{A} 901 and input IN_{B} 902 to different MP circuits according to the control signal CFG[1:0].

For example, for a first timestep, when control signal CFG[1:0]=2′b00, connector array 910 connects input bits IN_{A} and input IN_{B} to respective MP circuit 210a-210d via solid arrows; and in this case, MP circuit 210a produces OUT[3]=IN_{A}[3]×IN_{B}[3], MP circuit 210b produces OUT[2]=IN_{A}[2]×IN_{B}[2], MP circuit 210c produces OUT[1]=IN_{A}[1]×IN_{B}[1], and MP circuit 210d produces OUT[0]=IN_{A}[0]×IN_{B}[0].

For a second timestep, when control signal CFG[1:0]=2′b01, connector array 910 connects input bits IN_{A} and input IN_{B} to respective MP circuit 210a-210d via dashed arrows; and in this case, MP circuit 210a produces OUT[3]=0, MP circuit 210b produces OUT[2]=IN_{A}[2]×IN_{A}[3], MP circuit 210c produces OUT[1]=0, and MP circuit 210d produces OUT[0]=IN_{A}[0]×IN_{A}[1].

For a third timestep, when control signal CFG[1:0]=2′b1X, connector array 910 connects input bits IN_{A} and input IN_{B} to respective MP circuit 210a-210d via dotted arrows; and in this case, MP circuit 210a produces OUT[3]=IN_{A}[3]×IN_{B}[0], MP circuit 210b produces OUT[2]=IN_{A}[2]×IN_{B}[0], MP circuit 210c produces OUT[1]=IN_{A}[1]×IN_{B}[0], and MP circuit 210d produces OUT[0]=IN_{A}[0]×IN_{B}[0].

In this way, MP circuits 210a-210d may be used to compute a softmax operation, e.g., for the third step, IN_{A}[3]=x1, IN_{A}[2]=x2, IN_{A}[1]=x3, IN_{A}[0]=x4, IN_{B}[0]=1/(x1+x2+x3+x4), then MP circuits 210a-210d produce x1/(x1+x2+x3+x4), x2/(x1+x2+x3+x4), x3/(x1+x2+x3+x4) and x4/(x1+x2+x3+x4), respectively.

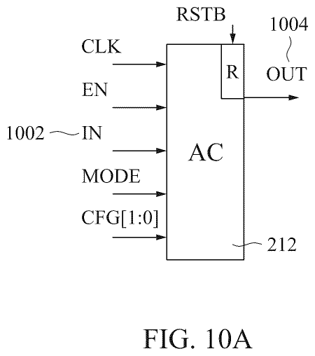

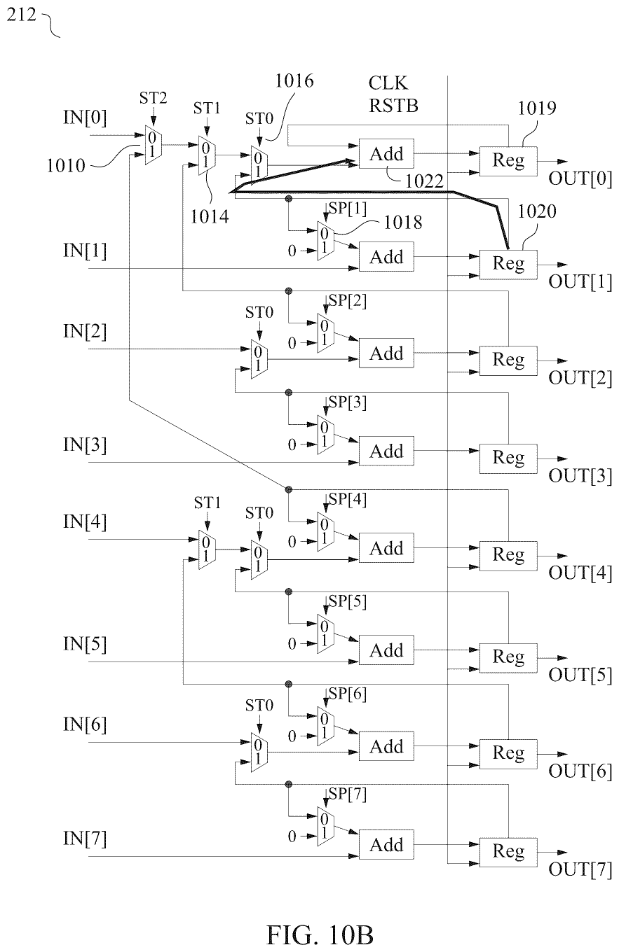

FIG. 10A is a simplified diagram illustrating a circuit structure of the AC circuit 212 shown in FIG. 2, according to one or more embodiments described herein. In one embodiment, the AC circuit 212 may compute the sum between the input IN 1002 and output OUT 1004, e.g., “accumulating.” The AC circuit 212 is synchronized with other circuits in ALU 200 shown in FIG. 2 with the clock signal CLK, and may be reset by the RST signal. The AC circuit 212 comprises a register such that the output OUT 1004 is registered and driven out at the rising edge of the CLK signal. The EN signal enables the AC circuit 212; the MODE signal indicates the number format for the AC circuit 212; the CFG control signal contains two bits to indicate four configurations, e.g., CFG[1:0]=2′b00, channel-wise accumulation OUT[t=1]=IN[t=1]+OUT[t=0]; CFG[1:0]=2′b01, cross-channel accumulation OUT[n]=OUT[n]+OUT[n+1]; CFG[1:0]=2′b10, cross-channel accumulation OUT[n]=OUT[n]+OUT[n+2]; CFG[1:0]=2′b11, cross-channel accumulation OUT[n]=OUT[n]+OUT[n+4]. Additional operations according to the control signal CFG[1:0] are described below in relation to FIG. 10B.

FIG. 10B is a simplified diagram illustrating a circuit structure of the AC circuit 212 shown in FIG. 10A, according to one or more embodiments described herein. As shown in FIG. 10B, AC circuit 212 may receive an 8-bit integer IN[0:7]. Each bit IN[0]-IN[7] may be selectively, via one or more multiplexers, to an adder to compute an accumulated sum.

In one embodiment, the control signal CFG[1:0] may be further mapped to selection signals to various multiplexers 1010, 1014, 1016, 1018 and/or the like inside the AC circuit 212. For example, CFG[1:0] may be mapped to selection signals ST₀ for multiplexer 1016, ST₁ for multiplexer 1014, ST₂ for multiplexer 1010, SP[1] for multiplexer 1018, and/or the like. Table 1 provides a mapping from CFG[1:0] to ST₀, ST₁, ST₂, and SP[1:7].

TABLE 1
AC Control Signals

| CFG[1:0] | ST2 | ST1 | ST0 | SP[1:7] |
|---|---|---|---|---|
| 2′b00 | 1′b0 | 1′b0 | 1′b0 | 7′b0000000 |
| 2′b01 | 1′b0 | 1′b0 | 1′b1 | 7′b1010101 |
| 2′b10 | 1′b0 | 1′b1 | 1′b1 | 7′b1110111 |
| 2′b11 | 1′b1 | 1′b1 | 1′b1 | 7′b1111111 |

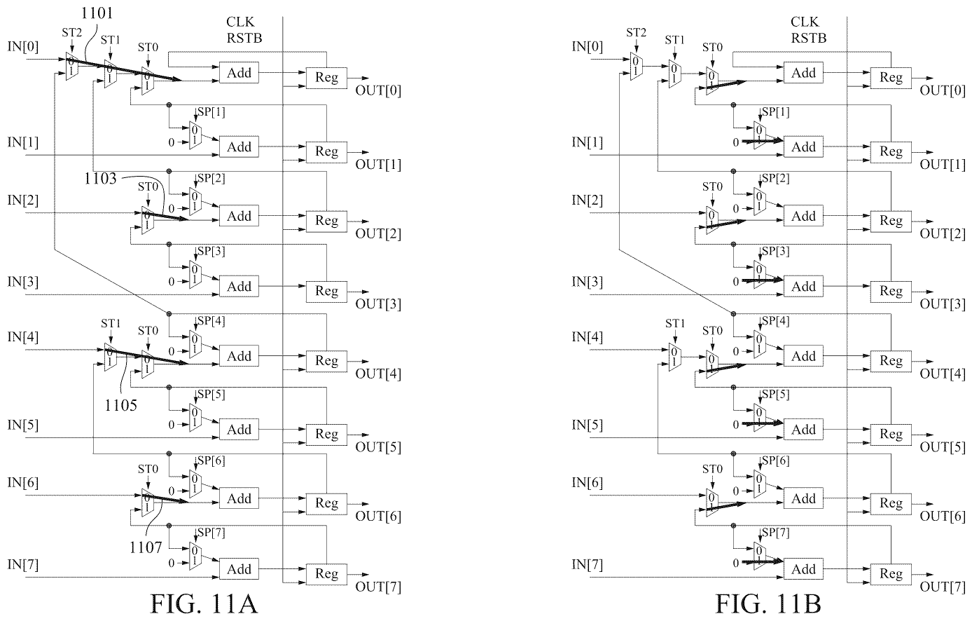

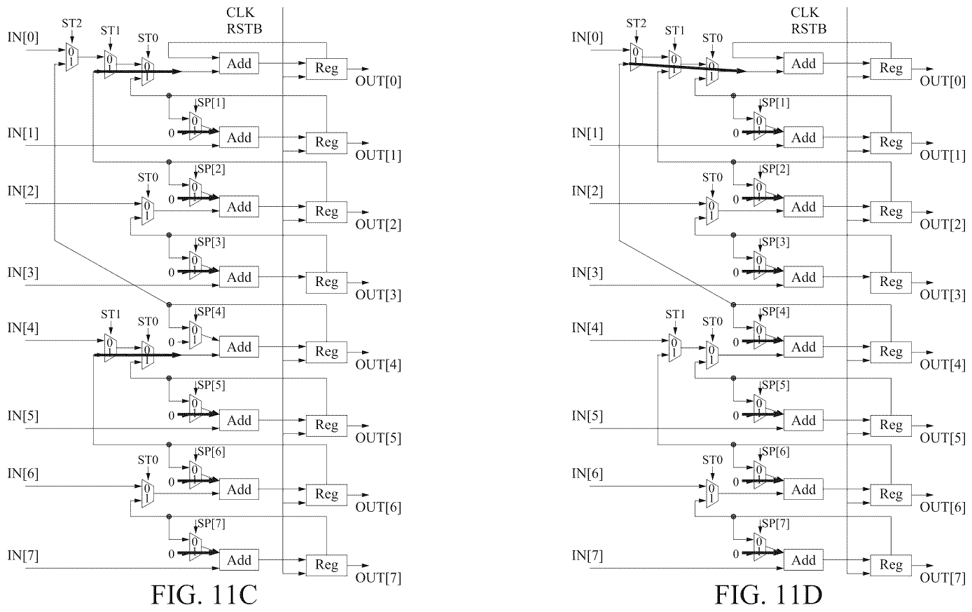

In one embodiment, output bits may be accumulated. For example, OUT[1] computed from a previous timestep may be output from register 1020 and add with OUT[0] from register 1019 at adder 1022. Similarly, OUT[2], . . . , OUT[7] may be accumulated to another output bit. Additional details on the accumulation operation of the circuit structure 212 may be described below in relation to FIGS. 11A-11D.

FIGS. 11A-11D are simplified diagrams illustrating multiple cycles of operating the AC circuit 212 shown in FIGS. 10A-10B, according to one or more embodiments described herein. As shown in FIG. 11A, at cycle #1, control signal CFG[1:0]=2′b00, which is mapped to control signals ST₀=1′b0, ST1=1′b0, ST₂=1′b0, and SP[1:7]=7′b0000000 according to Table 1. Data paths are shown in thickened bold arrows. Thus, assuming all OUT=0 prior to Cycle #1, input IN[0] may be passed through data path 1101 through multiple multiplexers controlled by selection signals ST₀, ST₁, ST₂ to the adder which produces OUT[0]=IN[0]. IN[1] is also passed to the added to produce OUT[1]=IN[1]. IN[2] is passed through data path 1103 to the adder which produces OUT[2]=IN[2]. And similarly, IN[3], IN[4], IN[5], IN[6], IN[7] are all passed to the respective adder, e.g., via data paths 1105, 1107 and or the like to produce OUT[n]|t=1=IN[n]|t=1.

At Cycle #2, control signal CFG[1:0]=2′b00, which is mapped to control signals ST₀=1′b0, ST1=1′b0, ST₂=1′b0, and SP[1:7]=7′b0000000 according to Table 1. Then, IN[n] are still passed to the respective adders following the same data paths 1101, 1103, 1105, 1107. Therefore, the adders produce OUT[n]|t=2=OUT[n]|t=1+IN[n]|t=2.

As shown in FIG. 11B, at cycle #3, control signal CFG[1:0]=2′b01, which is mapped to control signals ST₀=1′b1, ST1=1′b0, ST₂=1′b0, and SP[1:7]=7′b1010101 according to Table 1. Thus, the multiplexers controlled by the control signals form data paths are shown in thickened bold arrows. For example:

$$OUT [ 0 ] \vert t \text{=3=O} UT [ 0 ] \vert t \text{=2+O} UT [ 1 ] \vert t \text{=2=} sum ( OUT [ 1:0 ) \vert t \text{=2} ;$$

$$OUT [ 1 ] \vert t \text{=3=O} UT [ 1 ] \vert t \text{=2+I} N [ 1 ] \vert t \text{=3} ;$$

$$OUT [ 2 ] \vert t \text{=3=O} UT [ 2 ] \vert t \text{=2+O} UT [ 3 ] \vert t \text{=2=s} um ( OUT [ 3:2 ) \vert t \text{=2} ;$$

$$OUT [ 3 ] \vert t \text{=3=O} UT [ 3 ] \vert t \text{=2+I} N [ 3 ] \vert t \text{=3} ;$$

$$OUT [ 4 ] \vert t \text{=3=O} UT [ 4 ] \vert t \text{=2+O} UT [ 5 ] \vert t \text{=2=s} um ( OUT [ 5:4 ) \vert t \text{=2} ;$$

$$OUT [ 5 ] \vert t \text{=3=O} UT [ 5 ] \vert t \text{=2+I} N [ 5 ] \vert t \text{=3} ;$$

$$OUT [ 6 ] \vert t \text{=3=O} UT [ 6 ] \vert t \text{=2+O} UT [ 7 ] \vert t \text{=2=s} um ( OUT [ 7:6 ) \vert t \text{=2} ;$$

$$OUT [ 7 ] \vert t \text{=3=O} UT [ 7 ] \vert t \text{=2+I} N [ 7 ] \vert t \text{=3} ;$$

As shown in FIG. 11C, at cycle #4, control signal CFG[1:0]=2′b10, which is mapped to control signals ST₀=1′b1, ST1=1′b1, ST₂=1′b1, and SP[1:7]=7′b1110111 according to Table 1. Thus, the multiplexers controlled by the control signals form data paths are shown in thickened bold arrows. For example:

$$OUT [ 0 ] \vert t \text{=4} = sum ( OUT [ 3:0 ] \vert t \text{=3)} ;$$

$$OUT [ 4 ] \vert t \text{=4} = sum ( OUT [ 7:4 ] \vert t \text{=3)} .$$

As shown in FIG. 11D, at cycle #5, control signal CFG[1:0]=2′b11, which is mapped to control signals ST₀=1′b1, ST1=1′b1, ST₂=1′b1, and SP[1:7]=7′b1111111 according to Table 1. Thus, the multiplexers controlled by the control signals form data paths are shown in thickened bold arrows. For example:

$$OUT [ 0 ] \vert t \text{=5=O} UT [ 4 ] \vert t \text{=4} + OUT [ 0 ] \vert t \text{=4} = sum ( OUT [ 7:0 ] \vert t \text{=3} )$$

Therefore, in this way, the AC circuit 212 accumulates input bits that are passed to the output.

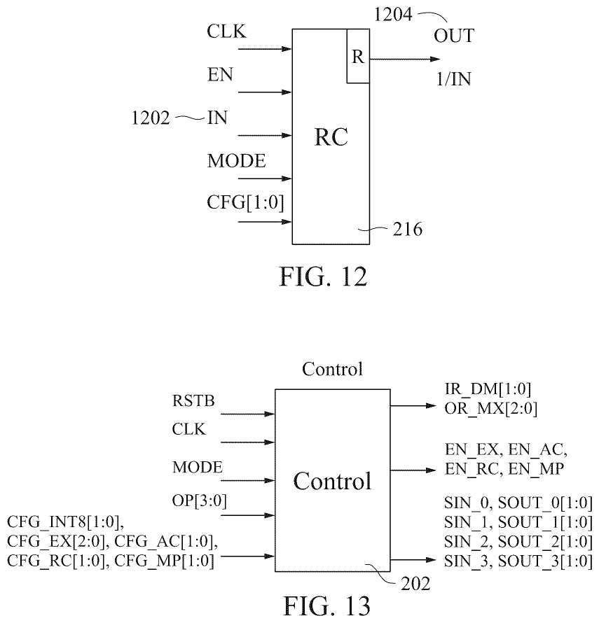

FIG. 12 is a simplified diagram illustrating a circuit structure of the RC circuit 216 shown in FIG. 2, according to one or more embodiments described herein. In one embodiment, RC 216 may compute the reciprocal of input IN 1202 and drives the result to output OUT 1204 at the rising edge of CLK signal. RC 216 is synchronized with other circuits in ALU 200 shown in FIG. 2 with the clock signal CLK, and may be reset by the RST signal. The EN signal enables the RC circuit 216; the MODE signal indicates the number format for the RC circuit 216; the CFG control signal contains two bits to indicate the number of cycles required.

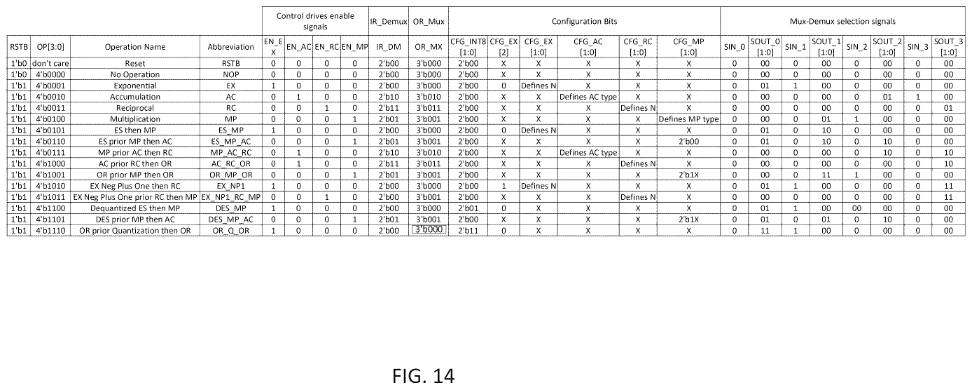

FIG. 13 is a simplified diagram illustrating a circuit structure of the control circuit 202 shown in FIG. 2, according to one or more embodiments described herein. In one embodiment, control circuit 202 may configure various control signals described in FIGS. 2-12. Control circuit 202 is synchronized with other circuits in ALU 200 shown in FIG. 2 with the clock signal CLK, and may be reset by the RST signal. The EN signal enables the control circuit 202; the MODE signal indicates the number format for the RC circuit 216. FIG. 14 shows example control signal configuration for different operations.

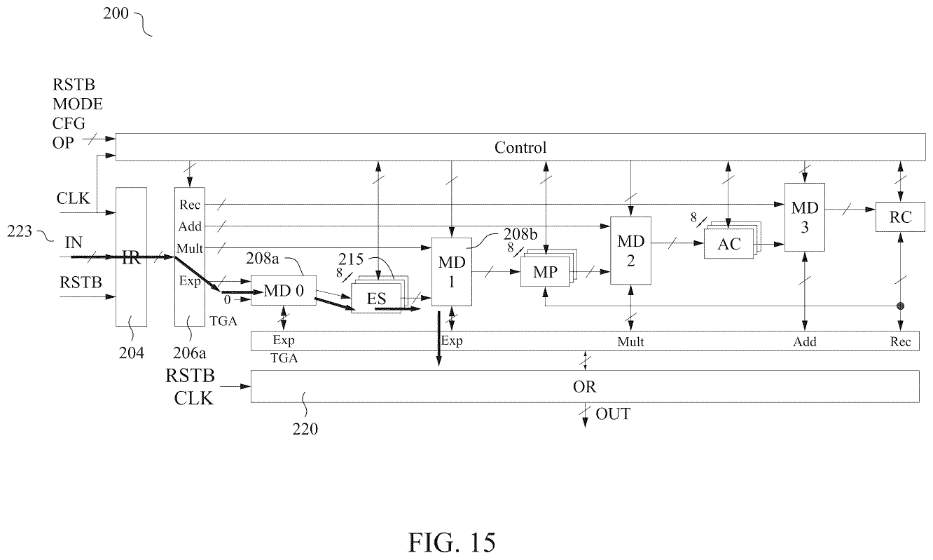

FIG. 15 is a simplified diagram illustrating an exponential computation operation by ALU 200 shown in FIG. 2, according to one or more embodiments described herein. According to FIG. 14, for an exponential operation, control signals EN_EX=1, IR_DM=2′b00, OR_MX=3′b000, CFG_EX[2]=0, CFG_EX[1:0] defines N, SIN_0=1′b0, SOUT_0=1′b01, SIN_1=1′b1, SOUT_1[1:0]=2′b00, SIN_2=1′b0, SOUT_2[1:0]=2′b00, SIN_3=1′b0 and SOUT_3[1:0]=2′b00. Thus input value IN 223 may be passed through IR 204, TGA 206a, MD 208a and ES 215 following the data path (shown by the thickened bold arrow).

In one embodiment, TGA 206a may pass IN to MD 208a, which in turn selects to pass through IN when S_{OUT}_0=1′b01 controls multiplexer 420 in FIG. 4. ES circuit 215 may then compute an exponential value of input IN, as described in relation to FIGS. 6A-6C. At MD 208b, the exponential result from ES circuit 215 is selected to be output when S_{IN}_1=1′b1 controls demultiplexer 410 in FIG. 4. Therefore, the exponential result from ES circuit 215 may eventually be passed on to OR 220 and output from ALU 200.

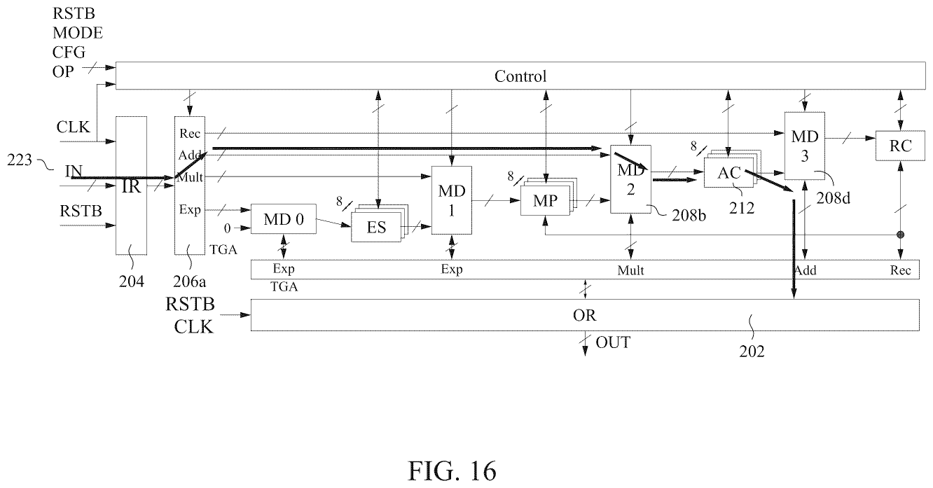

FIG. 16 is a simplified diagram illustrating a single accumulation operation by ALU 200 shown in FIG. 2, according to one or more embodiments described herein. According to FIG. 14, for an accumulation operation, control signals EN_AC=1, IR_DM=2′b01, OR_MX=3′b001, CFG_AC[1:0] defines AC type, SIN_0=1′b0, SOUT_0=1′b00, SIN_1=1′b0, SOUT_1[1:0]=2′b01, SIN_2=1′b1, SOUT_2[1:0]=2′b01, SIN_3=1′b0, SOUT_3[1:0]=2′b00. Thus input value IN 223 may be passed through IR 204, TGA 206a, MD 208d and AC 212 following the data path (shown by the thickened bold arrow).

In one embodiment, TGA 206a may pass IN to MD 208b, which in turn selects to pass through IN when S_{OUT}_=1′b01 controls multiplexer 420 in FIG. 4. AC circuit 212 may then compute an accumulation of the input over time, as described in relation to FIGS. 10A-10B and 11A-11D. At MD 208d, the accumulation result from AC circuit 212 is selected to be output when S_{IN}_3=1′b1 controls demultiplexer 410 in FIG. 4. Therefore, the accumulation result from ES circuit 215 may eventually be passed on to OR 202 and output from ALU 200.

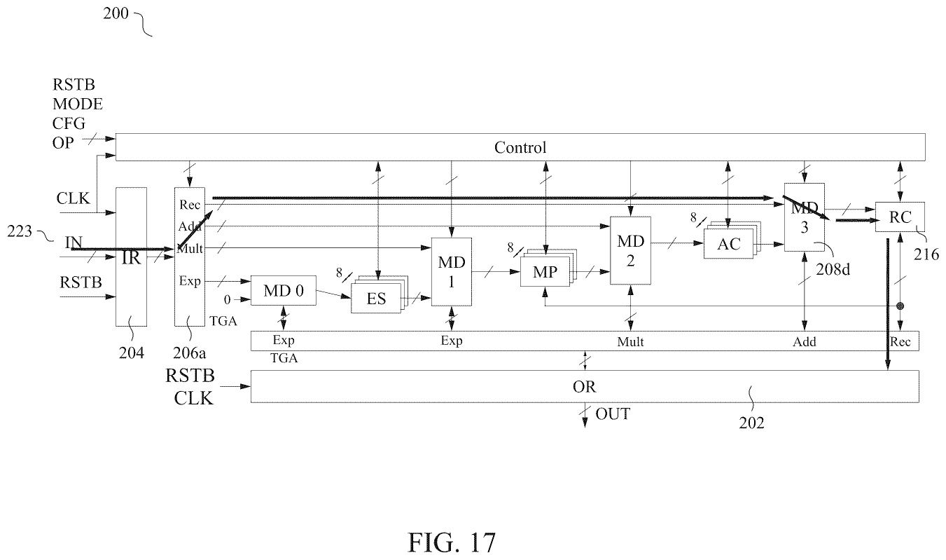

FIG. 17 is a simplified diagram illustrating a single reciprocal operation by ALU 200 shown in FIG. 2, according to one or more embodiments described herein. According to FIG. 14, for a reciprocal operation, control signals EN_MP=1, IR_DM=2′b1, OR_MX=3′b011, CFG_RC[1:0] defines N, SIN_1=1′b0, SOUT_1[1:0]=2′b01, SIN_2=1′b1, SOUT_2[1:0]=2′b00, SIN_3=1′b0, SOUT_3[1:0]=2′b00. Thus input value IN 223 may be passed through IR 204, TGA 206a, MD 208d and RC 216 following the data path (shown by the thickened bold arrow).

In one embodiment, TGA 206a may pass IN to MD 208d, which in turn selects to pass through IN when S_{OUT}_3=1′b01 controls multiplexer 420 in FIG. 4. RC circuit 216 may then compute a reciprocal of the input over time, as described in relation to FIG. 12. The reciprocal result from RC circuit 216 is passed on to OR 202 and output from ALU 200.

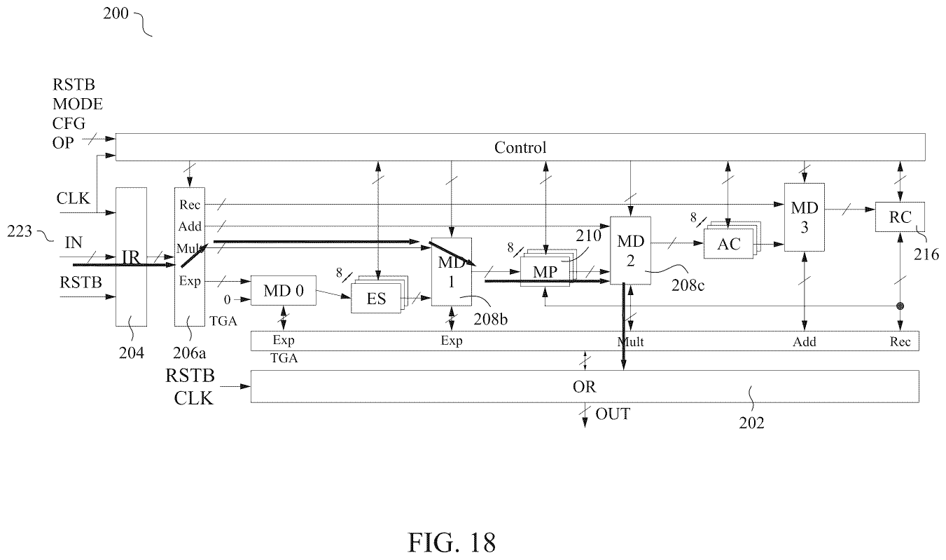

FIG. 18 is a simplified diagram illustrating a single multiplication operation by ALU 200 shown in FIG. 2, according to one or more embodiments described herein. According to FIG. 14, for a reciprocal operation, control signals EN_RC=1, IR_DM=2′b10, OR_MX=3′b010, CFG_RC[1:0] defines N, SIN_1=1′b0, SOUT_1[1:0]=2′b00, SIN_2=1′b0, SOUT_2[1:0]=2′b00, SIN_3=1′b0, SOUT_3[1:0]=2′b01. Thus input value IN 223 may be passed through IR 204, TGA 206a, MD 208b, MP 210, MD 208c following the data path (shown by the thickened bold arrow).

In one embodiment, TGA 206a may pass IN to MD 208b, which in turn selects to pass through IN when S_{OUT}_1=1′b01 controls multiplexer 420 in FIG. 4. MP circuit 210 may then multiply input IN and a reciprocal result from RC 216, as described in relation to FIGS. 9A-9B. The multiplication result is passed on to MD 208c, which in turn output the multiplication result when S_{IN}_2=1′b1 controls demultiplexer 410 in FIG. 4. The multiplication result is eventually passed to OR 202 and output from ALU 200.

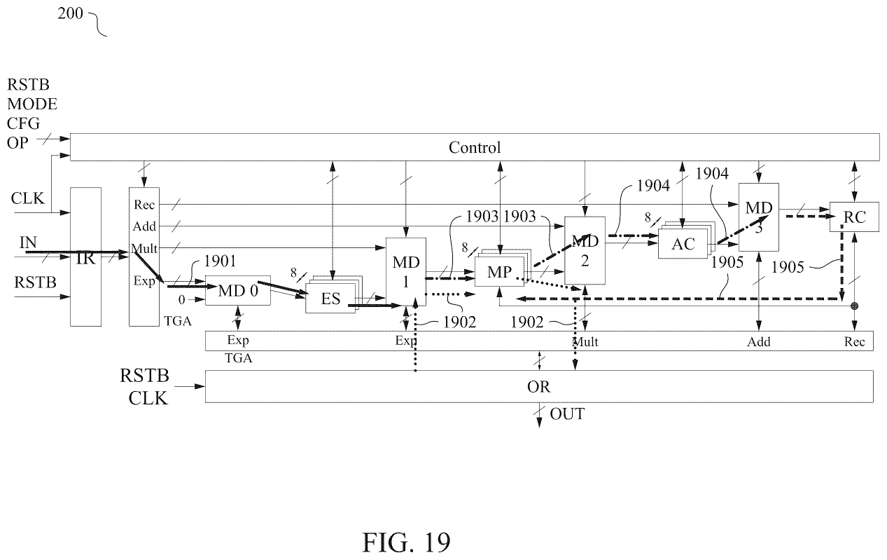

FIG. 19 is a simplified diagram illustrating a combined operation combining multiple single operations described in FIGS. 15-18 to perform a Softmax operation by ALU 200 shown in FIG. 2, according to one or more embodiments described herein. In one embodiment, a Softmax operation:

$${softmax ( x )}_{i} = \frac{{e}^{{x}_{i} - max ( x )}}{{\sum }_{j = 1}^{n} {e}^{{x}_{i} - max ( x )}}$$

may be decomposed into a sequence of single operations as described in FIGS. 15-18.

For example, given an input value x representing a vector of logits, the operation “ES then MIP” in FIG. 14, computes the exponential of integer part and exponential of the fractional part of each xi and then multiplies the two parts to obtain the exponential of x. This operation is performed via data path 1901 through IR, MD0, ES, MD1, and then via MP to multiply the exponential of integer and fractional parts. In this operation, the control signals may be configured according to the row of operation name “ES then MP” in FIG. 14.

Next, an operation of ES prior MP then AC in FIG. 14 computes e^{xi}×e^{-max(x)}. This operation is performed via data path 1903 through MP, MD2 (and then AC). In this operation, the control signals may be configured according to the row of operation name “ES prior MP then AC” in FIG. 14.

Next, an operation of MP prior AC then RC in FIG. 14 computes the denominator of softmax, a sum of e^{xi}×e^{-max}(x). This operation is performed via data path 1904 through AC, MD3 (and then RC). In this operation, the control signals may be configured according to the row of operation name “MP prior AC then RC” in FIG. 14.

Next, an operation of AC prior RC then OR in FIG. 14 computes the reciprocal of the denominator of softmax. This operation is performed via data path 1905 through RC (and then MP). In this operation, the control signals may be configured according to the row of operation name “AC prior RC then OR” in FIG. 14.

The last step, an operation of OR prior MP then OR in FIG. 14 computes the numerator times the reciprocal of the denominator of softmax, resulting in the final softmax. This operation is performed via data path 1902 through OR, MD1, MP, MD1 and then OR. Specifically, the computed and registered e^{xi}×e^{-max(x)} from the operation “ES prior MP then AC” is retrieved from OR, and is multiplied with the reciprocal of the denominator of softmax from the prior operation of AC prior RC then OR, to produce the final softmax result. In this operation, the control signals may be configured according to the row of operation name “OR prior MP then OR” in FIG. 14.

Therefore, ALU 200 may perform a softmax operation on an input value and output the softmax result via a sequence of operation commands: ES then MP, ES prior MP then AC, MP prior AC then RC, AC prior RC then OR and OR prior MP then OR. In this operation sequence, MP has been reused twice and the intermediate data is kept between each arithmetic units. OR is not accessed until the last operation to reduce register read and write operations, thus achieving high hardware efficiency.

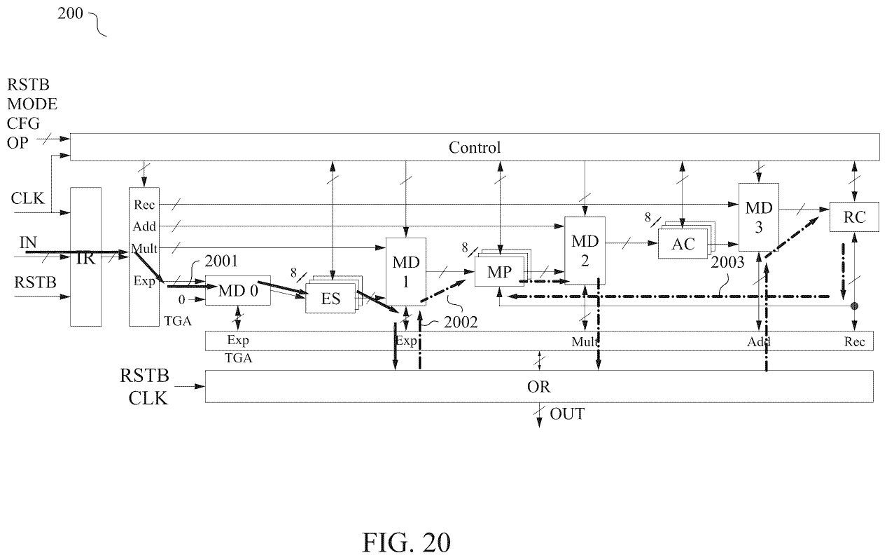

FIG. 20 is a simplified diagram illustrating a combined operation combining multiple single operations described in FIGS. 15-18 to perform a SiLU operation by ALU 200 shown in FIG. 2, according to one or more embodiments described herein. In one embodiment, a SiLU operation:

$${SiLU ( x )}_{i} = \frac{{x}_{i}}{1 + {e}^{- {x}_{i}}}$$

may be decomposed into a sequence of single operations as described in FIGS. 15-18.

For example, given an input value x representing a vector of intermediate variables between neural network layers, the operation “ES Neg Plus One then RC” in FIG. 14, computes the denominator of the SiLU, e.g., 1+e^{-x}. This operation is performed via data path 2001 through IR, MD0, ES, MD1, and then registered at OR. In this operation, the control signals may be configured according to the row of operation name “ES Neg Plus One then RC” in FIG. 14.

Next, an operation of “ES Neg Plus One then RC” in FIG. 14 computes the reciprocal of the denominator of SiLU, e.g., 1/(1+e^{-x}). This operation is performed via data path 2003 through OR (to retrieve the computed and registered denominator 1+e^{-x} from prior step), MD3, RC, MP. In this operation, the control signals may be configured according to the row of operation name “ES Neg Plus One then RC” in FIG. 14.

The last step, an operation of OR prior MP then OR in FIG. 14 computes the numerator times the reciprocal of the denominator of SiLU, resulting in the final SiLU. This operation is performed via data path 2002 through OR (to retrieve the registered value x), MD1, MP (to multiply retrieved x and computed 1/(1+e^{-x}) from prior step), MD2 and then OR. Specifically, MP multiples the registered input value x and computed 1/(1+e^{-x}) from prior operation of ES Neg Plus One then RC to produce the final SiLU result. In this operation, the control signals may be configured according to the row of operation name “OR prior MP then OR” in FIG. 14.

Therefore, ALU 200 may perform a SiLU operation on an input value and output the SiLU result via a sequence of operation commands: EX Neg Plus One then RC, EX Neg Plus One prior RC then MP and OR prior MP then OR.

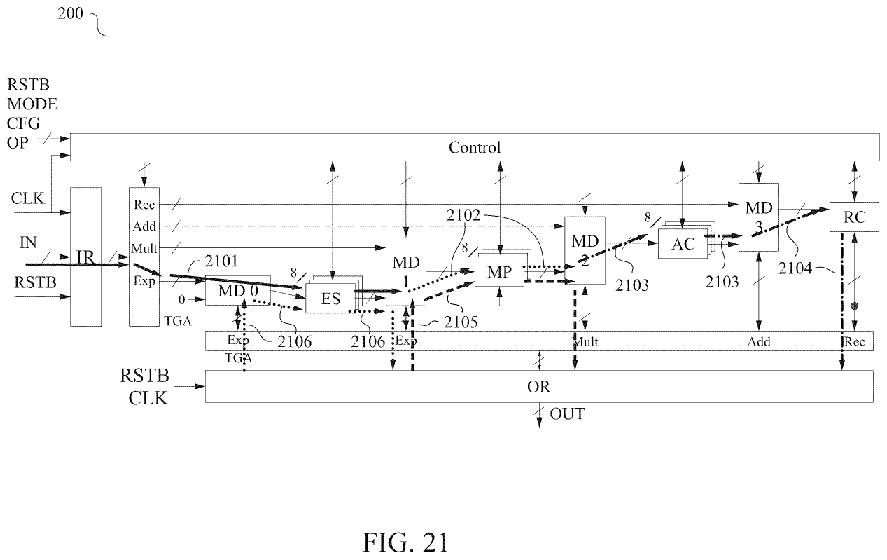

FIG. 21 is a simplified diagram illustrating a combined operation combining multiple single operations described in FIGS. 15-18 to perform an INT8 Softmax operation (dequantization of input and then quantization of the output) by ALU 200 shown in FIG. 2, according to one or more embodiments described herein. In this operation, input value x may be received in an INT8 (8-bit integer) format, and will first be converted (dequantized) to 16-bit floating point. The dequantized input value may then be used to compute the softmax result, which will then be converted back (quantized) to INT8.

For example, given an input value x of INT8 format, the operation “Dequant ES then MP” in FIG. 14, computes the exponential of integer part and exponential of the fractional part of each xi using the dequantization mode described in FIG. 7A-7B. This operation is performed via data path 2101 through IR, MD0, ES, MD1. In this operation, the control signals may be configured according to the row of operation name “Dequant ES then MP” in FIG. 14. The output of this operation is 16-bit floating point.

Next, an operation of DES prior MP then AC in FIG. 14 computes e^{xi}×e^{-max(x)}. This operation is performed via data path 2102 through MP, MD2 (and then AC). In this operation, the control signals may be configured according to the row of operation name “DES prior MP then AC” in FIG. 14.

Next, an operation of MP prior AC then RC in FIG. 14 computes the denominator of softmax, a sum of e^{xi}×e^{-max(x)}. This operation is performed via data path 2103 through AC, MD3 (and then RC). In this operation, the control signals may be configured according to the row of operation name “MP prior AC then RC” in FIG. 14.

Next, an operation of AC prior RC then OR in FIG. 14 computes the reciprocal of the denominator of softmax. This operation is performed via data path 2104 through RC (and then OR). In this operation, the control signals may be configured according to the row of operation name “AC prior RC then OR” in FIG. 14.

Next, an operation of OR prior MP then OR in FIG. 14 computes the numerator times the reciprocal of the denominator of softmax, resulting in the final softmax. This operation is performed via data path 2105 through OR, MD1, MP, MD1 and then OR. Specifically, the computed and registered e^{xi}×e^{-max(x)} from the operation “ES prior MP then AC” is retrieved from OR, and is multiplied with the reciprocal of the denominator of softmax from the prior operation of AC prior RC then OR, to produce the softmax result in 16-bit floating point.

The last step, an operation of OR prior Quant then OR in FIG. 14 quantize the softmax result in floating point into INT8. This operation is performed via data path 2106 through OR, MD0, ES, MD1 and then OR. The quantization is similar to embodiments described in FIG. 8A-8B. In this operation, the control signals may be configured according to the row of operation name “OR prior Quant then OR” in FIG. 14.

Therefore, ALU 200 may perform an INT8 softmax operation on an INT8 input value and output the softmax result in INT8 via a sequence of operation commands: Dequant ES then MP, DES prior MP then AC, MP prior AC then RC, AC prior RC then OR and OR prior MP then OR, and finally OR prior Quant then OR. This operation sequence is different from the operation sequence for softmax described in FIG. 19 with additional operations to dequantize the input and then quantize the output.

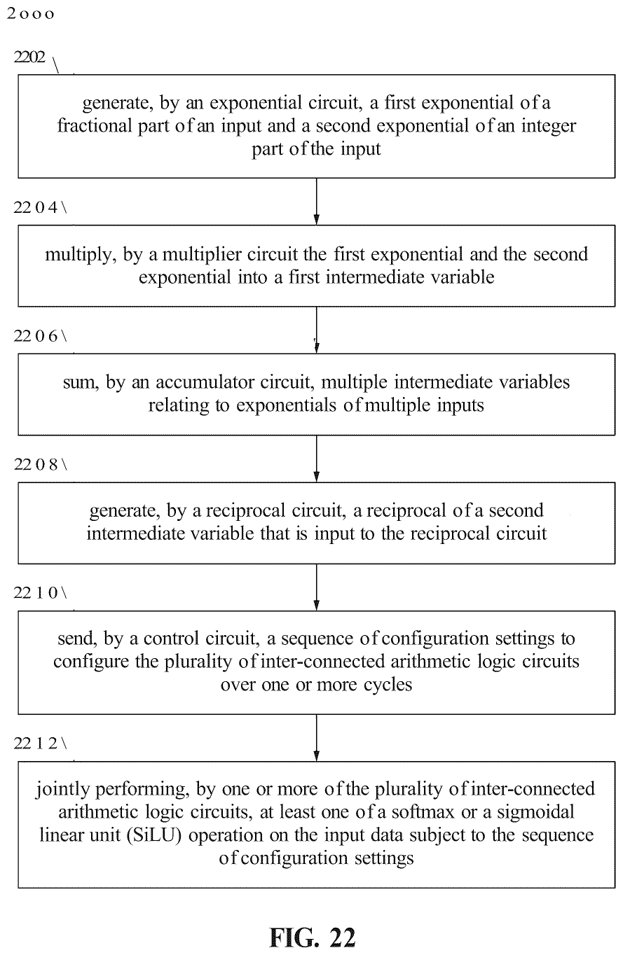

FIG. 22 is an example logic flow chart illustrating a process 2200 for transforming input data in a neural network to output data using a plurality of inter-connected arithmetic logic circuits described in FIGS. 2-21, according to embodiments described herein. One or more of the processes of method 2200 may be implemented, at least in part, in the form of executable code stored on non-transitory, tangible, machine-readable media that when run by one or more processors may cause the one or more processors to perform one or more of the processes. In some embodiments, method 2200 corresponds to the operation of the ALU 200 shown in FIGS. 2-21.

As illustrated, the method 2200 includes a number of enumerated steps, but aspects of the method 2200 may include additional steps before, after, and in between the enumerated steps. In some respects, one or more of the enumerated steps may be omitted or performed in a different order.

In one embodiment, the plurality of inter-connected arithmetic logic circuits are configured by different configuration settings depending on different types of the input data, such as 16-point half precision floating point (FP16), 16-point brain floating point (BF16), and 8-bit integer (INT8). The plurality of inter-connected arithmetic logic circuits are thus compatible to support operations of different data formats.

At step 2202, an exponential circuit (e.g., ES 215 in FIG. 2) may generate a first exponential of a fractional part of an input and a second exponential of an integer part of the input. For example, the configuration settings comprise at least one control signal to configure whether the exponential circuit operates under a dequantization mode or a quantization mode, as described in relation to FIGS. 6A-8B.

At step 2204, a multiplier circuit (e.g., MP 210 in FIG. 2) may multiply the first exponential and the second exponential into a first intermediate variable. For example, the configuration settings comprise at least one control signal to configure whether the multiplier circuit multiplies two inputs to the multiplier circuit, or one input to the multiplier circuit and another input to a different multiplier circuit, as described in relation to FIGS. 9A-9B.

At step 2206, an accumulator circuit (e.g., AC 212 in FIG. 2) may sum multiple intermediate variables relating to exponentials of multiple inputs. For example, the configuration settings comprise at least one control signal to configure whether the accumulation circuit sums an input and an output of a same adder, or two outputs of two different adders, as described in relation to FIGS. 10A-10B.

At step 2208, a reciprocal circuit (e.g., RC 216 in FIG. 2) may generate a reciprocal of a second intermediate variable that is input to the reciprocal circuit. For example,

At step 2210, a control circuit (e.g., Control 202 in FIG. 2) may send a sequence of configuration settings (e.g., control settings in FIG. 14) to configure the plurality of inter-connected arithmetic logic circuits over one or more cycles. Then one or more of the plurality of inter-connected arithmetic logic circuits may jointly perform at least one of a softmax or a sigmoidal linear unit (SiLU) operation on the input data subject to the sequence of configuration settings.

In one implementation of step 2210, the sequence of configuration settings configure the plurality of inter-connected arithmetic logic circuits to jointly perform the softmax operation that is decomposed into a sequence of operations over multiple cycles, including: an exponential operation, followed by a first multiplication operation, followed by an accumulation operation, followed by a reciprocal operation, flowed by a second multiplication operation, wherein the first multiplication operation and the second multiplication are both performed by the multiplication circuit, as described in FIG. 19.

In one implementation of step 2210, the sequence of configuration settings configure the plurality of inter-connected arithmetic logic circuits to jointly perform the SiLU operation that is decomposed into a sequence of operations over multiple cycles, including: a negative exponential plus one operation, followed by a reciprocal operation, followed by a multiplication operation, as described in FIG. 20.

In one implementation of step 2210, the sequence of configuration settings configure the plurality of inter-connected arithmetic logic circuits to jointly perform the softmax operation on an INT8 input, the softmax operation being decomposed into a sequence of operations over multiple cycles, including: an exponential operation in a dequantization mode to dequantize the INT8 input, followed by a first multiplication operation, followed by an accumulation operation, followed by a reciprocal operation, flowed by a second multiplication operation, and followed by a quantization operation to quantize an INT8 output. Here, the quantization operation is performed by the exponential circuit in a quantization mode, as described in FIG. 21.

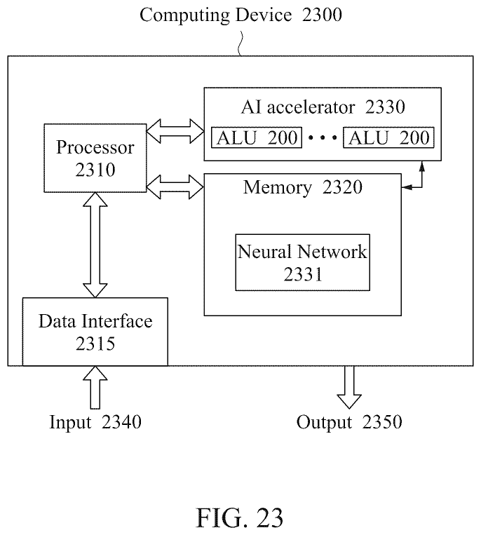

FIG. 23 is a simplified diagram illustrating a computing device implementing a neural network on an AI accelerator comprising the circuit structures described in FIGS. 1-22, according to one embodiment described herein. As shown in FIG. 23, computing device 2300 includes a processor 2310 coupled to memory 2320. Operation of computing device 2300 is controlled by processor 2310. And although computing device 2300 is shown with only one processor 2310, it is understood that processor 2310 may be representative of one or more central processing units, microcontrollers, multi-core processors, microprocessors, microcontrollers, digital signal processors, field programmable gate arrays (FPGAs), application specific integrated circuits (ASICs), graphics processing units (GPUs) and/or the like in computing device 2300. Computing device 2300 may be implemented as a stand-alone subsystem, as a board added to a computing device, and/or as a virtual machine.

Memory 2320 may be used to store software executed by computing device 2300 and/or one or more data structures used during operation of computing device 2300. Memory 2320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 2310 and/or memory 2320 may be arranged in any suitable physical arrangement. In some embodiments, processor 2310 and/or memory 2320 may be implemented on a same board, in a same package (e.g., system-in-package), on a same chip (e.g., system-on-chip), and/or the like. In some embodiments, processor 2310 and/or memory 2320 may include distributed, virtualized, and/or containerized computing resources. Consistent with such embodiments, processor 2310 and/or memory 2320 may be located in one or more data centers and/or cloud computing facilities.

In another embodiment, processor 2310 may comprise multiple microprocessors and/or memory 2320 may comprise multiple registers and/or other memory elements such that processor 2310 and/or memory 2320 may be arranged in the form of a hardware-based neural network, as further described in FIGS. 1-21.

In some examples, memory 2320 may include non-transitory, tangible, machine readable media that includes executable code that when run by one or more processors (e.g., processor 2310) may cause the one or more processors to perform the methods described in further detail herein. For example, as shown, memory 2320 includes instructions for operating a neural network 2331.

Memory 2302 may further couple to an AI accelerator 2330, which may comprise ALUs such as ALU 200 described in FIG. 2, and the various circuits described in FIGS. 3-21.

The data interface 2315 may comprise a communication interface, a user interface (such as a voice input interface, a graphical user interface, and/or the like). For example, the computing device 2300 may receive the input 2340 (such as a training dataset) from a networked database via a communication interface. Or the computing device 2300 may receive the input 2340, such as an input image, from a user via the user interface, and generate an output 2350 (such as 130 in FIG. 1).

Some examples of computing devices, such as computing device 1400 may include non-transitory, tangible, machine readable media that include executable code that when run by one or more processors (e.g., processor 1410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Computing device 2300 may be comprised in a system for running one or more neural networks. The system comprises a splitter circuit splitting an input data value into an integer portion and a fractional portion, a compensation circuit generating a compensated fractional portion according at least a first output from a first comparator circuit comparing the fractional portion and a first threshold, a scheduler circuit dynamically determining a number of terms for approximating an exponential of the factional portion, and a Taylor expansion computation circuit computing a sum of the number of Taylor expansion terms for the compensated fractional portion.

In one exemplary aspect, the present disclosure is directed to a circuit for transforming input data in a neural network to output data. The circuit includes a plurality of inter-connected arithmetic logic circuits and a control circuit. The plurality of inter-connected arithmetic logic circuits includes an exponential circuit generating a first exponential of a fractional part of an input and a second exponential of an integer part of the input, a multiplier circuit multiplying the first exponential and the second exponential into a first intermediate variable, an accumulator circuit summing multiple intermediate variables relating to exponentials of multiple inputs, and a reciprocal circuit generating a reciprocal of a second intermediate variable that is input to the reciprocal circuit. The control circuit sends a sequence of configuration settings to configure the plurality of inter-connected arithmetic logic circuits over one or more cycles, thereby one or more of the plurality of inter-connected arithmetic logic circuits jointly performing at least one of a softmax or a sigmoidal linear unit (SiLU) operation on the input data subject to the sequence of configuration settings. In some embodiments, the circuit further includes one or more multiplexer-demultiplexer (mux-demux) units interleaved with the plurality of inter-connected arithmetic logic circuits. The configuration settings comprise one or more selection signals for the one or more mux-demux units to form one or more data paths among the inter-connected arithmetic logic circuits. The one or more data paths correspond to a sequence of arithmetic operations performed by one or more of the inter-connected arithmetic logic circuits. In some embodiments, the plurality of inter-connected arithmetic logic circuits are configured by different configuration settings depending on different types of the input data. The different types of the input data comprise 16-point half precision floating point (FP16), 16-point brain floating point (BF16), and 8-bit integer (INT8). In some embodiments, each of the plurality of inter-connected arithmetic logic circuits operates on a data format that accommodates a largest bit-width of sign, exponent and mantissa in FP16 and BF16. In some embodiments, the configuration settings comprise at least one control signal to configure whether the exponential circuit operates under a dequantization mode or a quantization mode. In some embodiments, the configuration settings comprise at least one control signal to configure whether the multiplier circuit multiplies two inputs to the multiplier circuit, or one input to the multiplier circuit and another input to a different multiplier circuit. In some embodiments, the configuration settings comprise at least one control signal to configure whether the accumulator circuit sums an input and an output of a same adder, or two outputs of two different adders. In some embodiments, the sequence of configuration settings configure the plurality of inter-connected arithmetic logic circuits to jointly perform the softmax operation that is decomposed into a sequence of operations over multiple cycles, including: an exponential operation, followed by a first multiplication operation, followed by an accumulation operation, followed by a reciprocal operation, flowed by a second multiplication operation, the first multiplication operation and the second multiplication both performed by the multiplication circuit. In some embodiments, the sequence of configuration settings configure the plurality of inter-connected arithmetic logic circuits to jointly perform the SiLU operation that is decomposed into a sequence of operations over multiple cycles, including: a negative exponential plus one operation, followed by a reciprocal operation, followed by a multiplication operation. In some embodiments, the sequence of configuration settings configure the plurality of inter-connected arithmetic logic circuits to jointly perform the softmax operation on an INT8 input, the softmax operation being decomposed into a sequence of operations over multiple cycles, including: an exponential operation in a dequantization mode to dequantize the INT8 input, followed by a first multiplication operation, followed by an accumulation operation, followed by a reciprocal operation, flowed by a second multiplication operation, and followed by a quantization operation to quantize an INT8 output, the quantization operation performed by the exponential circuit in a quantization mode.

In another exemplary aspect, the present disclosure is directed to a method for transforming input data in a neural network to output data using a plurality of inter-connected arithmetic logic circuits. The method includes generating, by an exponential circuit, a first exponential of a fractional part of an input and a second exponential of an integer part of the input, multiplying, by a multiplier circuit the first exponential and the second exponential into a first intermediate variable, summing, by an accumulator circuit, multiple intermediate variables relating to exponentials of multiple inputs, generating, by a reciprocal circuit, a reciprocal of a second intermediate variable that is input to the reciprocal circuit, sending, by a control circuit, a sequence of configuration settings to configure the plurality of inter-connected arithmetic logic circuits over one or more cycles, and jointly performing, by one or more of the plurality of inter-connected arithmetic logic circuits, at least one of a softmax or a sigmoidal linear unit (SiLU) operation on the input data subject to the sequence of configuration settings. In some embodiments, the plurality of inter-connected arithmetic logic circuits are interleaved with one or more multiplexer-demultiplexer (mux-demux) units, and the method further includes forming one or more data paths among the inter-connected arithmetic logic circuits through the one or more mux-demux units according to one or more selection signals from the configuration settings. The one or more data paths correspond to a sequence of arithmetic operations performed by one or more of the inter-connected arithmetic logic circuits. In some embodiments, the plurality of inter-connected arithmetic logic circuits are configured by different configuration settings depending on different types of the input data. The different types of the input data comprise 16-point half precision floating point (FP16), 16-point brain floating point (BF16), and 8-bit integer (INT8). In some embodiments, each of the plurality of inter-connected arithmetic logic circuits operates on a data format that accommodates a largest bit-width of sign, exponent and mantissa in FP16 and BF16. In some embodiments, the method further includes configuring, according to at least one control signal comprised in the configuration setting, whether the exponential circuit operates under a dequantization mode or a quantization mode. In some embodiments, the method further includes configuring, according to at least one control signal comprised in the configuration setting, whether the multiplier circuit multiplies two inputs to the multiplier circuit, or one input to the multiplier circuit and another input to a different multiplier circuit. In some embodiments, the method further includes configuring the plurality of inter-connected arithmetic logic circuits, according to the sequence of configuration settings, to jointly perform the softmax operation that is decomposed into a sequence of operations over multiple cycles, including: an exponential operation, followed by a first multiplication operation, followed by an accumulation operation, followed by a reciprocal operation, flowed by a second multiplication operation, the first multiplication operation and the second multiplication both performed by the multiplication circuit. In some embodiments, the method further includes configuring the plurality of inter-connected arithmetic logic circuits, according to the sequence of configuration settings, to jointly perform the softmax operation on an INT8 input, the softmax operation being decomposed into a sequence of operations over multiple cycles, including: an exponential operation in a dequantization mode to dequantize the INT8 input, followed by a first multiplication operation, followed by an accumulation operation, followed by a reciprocal operation, flowed by a second multiplication operation, and followed by a quantization operation to quantize an INT8 output, the quantization operation performed by the exponential circuit in a quantization mode.

In another exemplary aspect, the present disclosure is directed to a method for building a circuit of transforming input data in a neural network to output data. The method includes placing a plurality of inter-connected arithmetic logic circuits on the circuit. The plurality of inter-connected arithmetic logic circuits including an exponential circuit generating a first exponential of a fractional part of an input and a second exponential of an integer part of the input, a multiplier circuit multiplying the first exponential and the second exponential into a first intermediate variable, an accumulator circuit summing multiple intermediate variables relating to exponentials of multiple inputs, and a reciprocal circuit generating a reciprocal of a second intermediate variable that is input to the reciprocal circuit. A control circuit sends a sequence of configuration settings to configure the plurality of inter-connected arithmetic logic circuits over one or more cycles, thereby one or more of the plurality of inter-connected arithmetic logic circuits jointly performing at least one of a softmax or a sigmoidal linear unit (SiLU) operation on the input data subject to the sequence of configuration settings. In some embodiments, the plurality of inter-connected arithmetic logic circuits are configured by different configuration settings depending on different types of the input data. The different types of the input data comprise 16-point half precision floating point (FP16), 16-point brain floating point (BF16), and 8-bit integer (INT8).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A circuit for transforming input data in a neural network to output data, comprising:
a plurality of inter-connected arithmetic logic circuits including:
an exponential circuit generating a first exponential of a fractional part of an input and a second exponential of an integer part of the input;
a multiplier circuit multiplying the first exponential and the second exponential into a first intermediate variable;
an accumulator circuit summing multiple intermediate variables relating to exponentials of multiple inputs; and
a reciprocal circuit generating a reciprocal of a second intermediate variable that is input to the reciprocal circuit; and
a control circuit sending a sequence of configuration settings to configure the plurality of inter-connected arithmetic logic circuits over one or more cycles, thereby one or more of the plurality of inter-connected arithmetic logic circuits jointly performing at least one of a softmax or a sigmoidal linear unit (SiLU) operation on the input data subject to the sequence of configuration settings.

2. The circuit of claim 1, further comprising:
one or more multiplexer-demultiplexer (mux-demux) units interleaved with the plurality of inter-connected arithmetic logic circuits,
wherein the configuration settings comprise one or more selection signals for the one or more mux-demux units to form one or more data paths among the inter-connected arithmetic logic circuits,
wherein the one or more data paths correspond to a sequence of arithmetic operations performed by one or more of the inter-connected arithmetic logic circuits.

3. The circuit of claim 1, wherein the plurality of inter-connected arithmetic logic circuits are configured by different configuration settings depending on different types of the input data,
wherein the different types of the input data comprise 16-point half precision floating point (FP16), 16-point brain floating point (BF16), and 8-bit integer (INT8).

4. The circuit of claim 3, wherein each of the plurality of inter-connected arithmetic logic circuits operates on a data format that accommodates a largest bit-width of sign, exponent and mantissa in FP16 and BF16.

5. The circuit of claim 1, wherein the configuration settings comprise at least one control signal to configure whether the exponential circuit operates under a dequantization mode or a quantization mode.

6. The circuit of claim 1, wherein the configuration settings comprise at least one control signal to configure whether the multiplier circuit multiplies two inputs to the multiplier circuit, or one input to the multiplier circuit and another input to a different multiplier circuit.

7. The circuit of claim 1, wherein the configuration settings comprise at least one control signal to configure whether the accumulator circuit sums an input and an output of a same adder, or two outputs of two different adders.

8. The circuit of claim 1, wherein the sequence of configuration settings configure the plurality of inter-connected arithmetic logic circuits to jointly perform the softmax operation that is decomposed into a sequence of operations over multiple cycles, including:
an exponential operation, followed by a first multiplication operation, followed by an accumulation operation, followed by a reciprocal operation, flowed by a second multiplication operation, wherein the first multiplication operation and the second multiplication are both performed by the multiplication circuit.

9. The circuit of claim 1, wherein the sequence of configuration settings configure the plurality of inter-connected arithmetic logic circuits to jointly perform the SiLU operation that is decomposed into a sequence of operations over multiple cycles, including:
a negative exponential plus one operation, followed by a reciprocal operation, followed by a multiplication operation.

10. The circuit of claim 1, wherein the sequence of configuration settings configure the plurality of inter-connected arithmetic logic circuits to jointly perform the softmax operation on an INT8 input, the softmax operation being decomposed into a sequence of operations over multiple cycles, including:
an exponential operation in a dequantization mode to dequantize the INT8 input, followed by a first multiplication operation, followed by an accumulation operation, followed by a reciprocal operation, flowed by a second multiplication operation, and followed by a quantization operation to quantize an INT8 output,
wherein the quantization operation is performed by the exponential circuit in a quantization mode.

11. A method for transforming input data in a neural network to output data using a plurality of inter-connected arithmetic logic circuits, the method comprising:
generating, by an exponential circuit, a first exponential of a fractional part of an input and a second exponential of an integer part of the input;
multiplying, by a multiplier circuit the first exponential and the second exponential into a first intermediate variable;
summing, by an accumulator circuit, multiple intermediate variables relating to exponentials of multiple inputs;
generating, by a reciprocal circuit, a reciprocal of a second intermediate variable that is input to the reciprocal circuit;
sending, by a control circuit, a sequence of configuration settings to configure the plurality of inter-connected arithmetic logic circuits over one or more cycles; and
jointly performing, by one or more of the plurality of inter-connected arithmetic logic circuits, at least one of a softmax or a sigmoidal linear unit (SiLU) operation on the input data subject to the sequence of configuration settings.

12. The method of claim 11, wherein the plurality of inter-connected arithmetic logic circuits are interleaved with one or more multiplexer-demultiplexer (mux-demux) units, and wherein the method further comprises:
forming one or more data paths among the inter-connected arithmetic logic circuits through the one or more mux-demux units according to one or more selection signals from the configuration settings,
wherein the one or more data paths correspond to a sequence of arithmetic operations performed by one or more of the inter-connected arithmetic logic circuits.

13. The method of claim 11, wherein the plurality of inter-connected arithmetic logic circuits are configured by different configuration settings depending on different types of the input data,
wherein the different types of the input data comprise 16-point half precision floating point (FP16), 16-point brain floating point (BF16), and 8-bit integer (INT8).

14. The method of claim 13, wherein each of the plurality of inter-connected arithmetic logic circuits operates on a data format that accommodates a largest bit-width of sign, exponent and mantissa in FP16 and BF16.

15. The method of claim 1, further comprising:
configuring, according to at least one control signal comprised in the configuration setting, whether the exponential circuit operates under a dequantization mode or a quantization mode.

16. The method of claim 11, further comprising:
configuring, according to at least one control signal comprised in the configuration setting, whether the multiplier circuit multiplies two inputs to the multiplier circuit, or one input to the multiplier circuit and another input to a different multiplier circuit.

17. The method of claim 11, further comprising:
configuring the plurality of inter-connected arithmetic logic circuits, according to the sequence of configuration settings, to jointly perform the softmax operation that is decomposed into a sequence of operations over multiple cycles, including:
an exponential operation, followed by a first multiplication operation, followed by an accumulation operation, followed by a reciprocal operation, flowed by a second multiplication operation, wherein the first multiplication operation and the second multiplication are both performed by the multiplication circuit.

18. The method of claim 11, further comprising:
configuring the plurality of inter-connected arithmetic logic circuits, according to the sequence of configuration settings, to jointly perform the softmax operation on an INT8 input, the softmax operation being decomposed into a sequence of operations over multiple cycles, including:
an exponential operation in a dequantization mode to dequantize the INT8 input, followed by a first multiplication operation, followed by an accumulation operation, followed by a reciprocal operation, flowed by a second multiplication operation, and followed by a quantization operation to quantize an INT8 output,
wherein the quantization operation is performed by the exponential circuit in a quantization mode.

19. A method for building a circuit of transforming input data in a neural network to output data, the method comprising:
placing a plurality of inter-connected arithmetic logic circuits on the circuit, wherein the plurality of inter-connected arithmetic logic circuits including:
an exponential circuit generating a first exponential of a fractional part of an input and a second exponential of an integer part of the input;
a multiplier circuit multiplying the first exponential and the second exponential into a first intermediate variable;
an accumulator circuit summing multiple intermediate variables relating to exponentials of multiple inputs; and
a reciprocal circuit generating a reciprocal of a second intermediate variable that is input to the reciprocal circuit; and
a control circuit sending a sequence of configuration settings to configure the plurality of inter-connected arithmetic logic circuits over one or more cycles, thereby one or more of the plurality of inter-connected arithmetic logic circuits jointly performing at least one of a softmax or a sigmoidal linear unit (SiLU) operation on the input data subject to the sequence of configuration settings.

20. The method of claim 19, wherein the plurality of inter-connected arithmetic logic circuits are configured by different configuration settings depending on different types of the input data,
wherein the different types of the input data comprise 16-point half precision floating point (FP16), 16-point brain floating point (BF16), and 8-bit integer (INT8).
